(19) United States
(12) Patent Application Publication
(10) Pub. No.: US 2024/0376364 A1
(43) Pub. Date: Nov. 14, 2024

(54) HEAT STORAGE SHEET, RESIN PELLET, AND MOLDED PRODUCT

(71) Applicant: FUJIFILM Corporation, Tokyo (JP)

(72) Inventors: Masahiro HATTA, Shizuoka (JP); Rei MIYASAKA, Shizuoka (JP)

(73) Assignee: FUJIFILM Corporation, Tokyo (JP)

(21) Appl. No.: 18/779,099

(22) Filed: Jul. 22, 2024

Related U.S. Application Data
(63) Continuation of application No. PCT/JP2023/003036, filed on Jan. 31, 2023.

(30) Foreign Application Priority Data
Feb. 28, 2022 (JP) 2022-029544

(51) Int. Cl. C09K 5/06

(52) U.S. Cl. CPC C09K 5/063

(57) ABSTRACT

An object of the present invention is to provide a heat storage sheet having excellent followability and excellent heat resistance. In addition, another object of the present invention is to provide a resin pellet and a molded product.

A heat storage sheet according to the present invention contains a microcapsule that encompasses a phase change material, a first resin that has a repeating unit derived from an olefin and has a hydrophilic group, and a second resin that is a resin different from the first resin and has a repeating unit derived from an olefin, where a capsule wall of the microcapsule contains at least one resin W selected from the group consisting of polyurethane urea, polyurethane, and polyurea.

### CROSS-REFERENCE TO RELATED APPLICATIONS

This application is a Continuation of PCT International Application No. PCT/JP2023/003036 filed on Jan. 31, 2023, which claims priority under 35 U.S.C. § 119(a) to Japanese Patent Application No. 2022-029544 filed on Feb. 28, 2022. The above applications are hereby expressly incorporated by reference, in their entirety, into the present application.

### BACKGROUND OF THE INVENTION

### 1. Field of the Invention

The present invention relates to a heat storage sheet, a resin pellet, and a molded product.

### 2. Description of the Related Art

Although mobile devices such as a smartphone and a tablet PC have a small size, the functions and the performance thereof are improved, and the heat generation density is significantly increased. Since the thermal runaway or the thermal cycle fatigue of solder is accelerated by an increase in heat generation density, there is a demand for countermeasures in accordance with both the reinforcement of the countermeasures against heat and the improvement of reliability of the strength of the solder connecting portion in order to improve the reliability of the mobile device.

In recent years, passive cooling using a phase change material (PCM) has been attracting attention as a method of suppressing heat generation of electronic components. Due to the latent heat of fusion, the PCM can absorb heat with almost no change in the temperature. Therefore, it is possible to obtain an effect of delaying the time required for the temperature to increase, that is, a so-called delay effect.

As a member containing the PCM and having a function of storing heat that is generated outside, a heat storage body including a microcapsule that encompasses a phase change material such as paraffin has been known. For example, JP2019-137723A discloses a resin pellet containing a microcapsule that encompasses a phase change material and has a capsule wall composed of a melamine resin. WO2017/221727A discloses a heat storage sheet in which a microcapsule that encompasses a latent heat storage material in an outer shell of a resin is dispersed in a resin matrix.

### SUMMARY OF THE INVENTION

In electronic components, in association with the densification of semiconductors in recent years, an increase in frequency of generation of leakage current at a high temperature (for example, 80° C. or higher) has become a problem. In addition, in a case where electronic components such as a CPU and an image sensor are repeatedly exposed to a high temperature environment, cracking may occur due to a difference in expansion and contraction between materials at a joining part of different materials such as ceramics, a resin material, and a metal material. Further, in a case where electronic components are exposed to a high temperature environment for a long time, the deterioration of the electronic material may be accelerated. In order to prevent these events, a function of carrying out such a control to reduce the number of processes or stop the supply of electricity, thereby suppressing an increase in temperature is provided in electronic components. However, this function causes an operation delay due to a decrease in the processing speed of the PC or the game machine, a restriction on the capturing time during capturing of a moving image with a camera, or the like.

As a result of evaluating the respective characteristics of the heat storage body produced with reference to JP2019-137723A and WO2017/221727A, the inventors of the present invention have found that there is room for further improvement in the followability and the heat resistance of the heat storage body.

In a case where the followability of the heat storage body is low, it is considered that a gap is generated between the heat storage body and a surface shape of an object, and thus a heat absorption function of the heat storage body may not be sufficiently exhibited in a case where the heat storage body is applied to an object such as an electronic component, which has a surface shape such as a curved surface or an uneven shape (for example, a groove).

In addition, in a case where the heat resistance of the heat storage body is low, it is considered that the heat storage body may be deformed in a case where it is allowed to be present in a high temperature environment for a long time, and as a result, a gap may be generated between the heat storage body and the surface of the object, which deteriorates the adhesiveness.

In consideration of the above-described circumstances, an object of the present invention is to provide a heat storage sheet having excellent followability and excellent heat resistance. In addition, another object of the present invention is to provide a resin pellet and a molded product.

As a result of carrying out intensive studies to achieve the above-described object, the inventors of the present invention have found that the above-described object can be achieved by the following configurations.

[1] A heat storage sheet comprising:
a microcapsule that encompasses a phase change material;
a first resin that has a repeating unit derived from an olefin and has a hydrophilic group; and
a second resin that is a resin different from the first resin and has a repeating unit derived from an olefin,
in which a capsule wall of the microcapsule contains at least one resin W selected from the group consisting of polyurethane urea, polyurethane, and polyurea.

[2] The heat storage sheet according to [1],
in which the repeating unit derived from the olefin, which is contained in the first resin, includes a repeating unit derived from ethylene, and the repeating unit derived from the olefin, which is contained in the second resin, includes a repeating unit derived from ethylene, or
the repeating unit derived from the olefin, which is contained in the first resin, includes a repeating unit derived from propylene, and the repeating unit derived from the olefin, which is contained in the second resin, includes a repeating unit derived from propylene.

[3] The heat storage sheet according to [1], in which the repeating unit derived from the olefin, which is contained in the first resin, includes a repeating unit derived from propylene, and the repeating unit derived from the olefin, which is contained in the second resin, includes a repeating unit derived from propylene.

[4] The heat storage sheet according to any one of [1] to [3], in which the hydrophilic group is at least one group selected from the group consisting of a carboxy group, a carboxylic acid anhydride group, a hydroxy group, and an amino group.

[5] The heat storage sheet according to any one of [1] to [4], in which a thickness of the heat storage sheet is 200 μm or more.

[6] The heat storage sheet according to any one of [1] to [5], in which a melting point of the phase change material is 50° C. to 95° C.

[7] The heat storage sheet according to any one of [1] to [6], in which a content of the phase change material is 15% by mass or more with respect to a total mass of the heat storage sheet.

[8] The heat storage sheet according to any one of [1] to [7], in which the heat storage sheet is an extrusion molded product.

[9] The heat storage sheet according to any one of [1] to [8], in which a content of the second resin is 15% by mass or more with respect to a total mass of the heat storage sheet.

[10] The heat storage sheet according to any one of [1] to [9], in which a content of the second resin is larger than a content of the first resin.

[11] The heat storage sheet according to any one of [1] to [10], in which the resin W has a polymethylene polyphenylene structure.

[12] A resin pellet comprising:
a microcapsule that encompasses a phase change material;
a first resin that has a repeating unit derived from an olefin and has a hydrophilic group; and
a second resin that is a resin different from the first resin and has a repeating unit derived from an olefin,
in which a capsule wall of the microcapsule contains at least one resin W selected from the group consisting of polyurethane urea, polyurethane, and polyurea.

[13] The resin pellet according to [12], in which the hydrophilic group is at least one group selected from the group consisting of a carboxy group, a carboxylic acid anhydride group, a hydroxy group, and an amino group.

[14] The resin pellet according to [12] or [13], in which a melting point of the phase change material is 50° C. to 95° C.

[15] The resin pellet according to any one of [12] to [14], in which a content of the phase change material is 15% by mass or more with respect to a total mass of the resin pellet.

[16] The resin pellet according to any one of [12] to [15], in which the second resin is a thermoplastic resin, and a content of the thermoplastic resin is 15% by mass or more with respect to a total mass of the resin pellet.

[17] The resin pellet according to any one of [12] to [16], in which a content of the second resin is larger than a content of the first resin.

[18] A molded product comprising:
a microcapsule that encompasses a phase change material;
a first resin that has a repeating unit derived from an olefin and has a hydrophilic group; and
a second resin that is a resin different from the first resin and has a repeating unit derived from an olefin,
in which a capsule wall of the microcapsule contains at least one resin W selected from the group consisting of polyurethane urea, polyurethane, and polyurea.

According to the present invention, it is possible to provide a heat storage sheet having excellent followability and excellent heat resistance. In addition, according to the present invention, it is also possible to provide a resin pellet and a molded product.

### BRIEF DESCRIPTION OF THE DRAWINGS

FIG. 1 is a schematic view of a part of an image obtained by observing a cross section of a heat storage sheet with a scanning electron microscope.

### DESCRIPTION OF THE PREFERRED EMBODIMENTS

In the present specification, numerical value ranges expressed using “to” include numerical values before and after the “to” as the lower limit value and the upper limit value.

In the numerical value ranges disclosed stepwise in the present specification, an upper limit value or a lower limit value disclosed in a certain numerical value range may be replaced with an upper limit value or a lower limit value disclosed in another numerical value range disclosed in stepwise. In addition, in the numerical value ranges disclosed in the present specification, an upper limit value or a lower limit value disclosed in a certain numerical value range may be replaced with values shown in examples.

One kind of various components described below may be used alone, or two or more kinds thereof may be mixedly used. For example, one kind of resin described below may be used alone, or two or more kinds thereof may be mixedly used.

In the present specification, in a case where there are a plurality of substances corresponding to cach component, the amount of each component in a composition, a layer, or a mixture means the total amount of the plurality of substances present in the composition, the layer, or the mixture, unless otherwise specified.

In the present specification, the term “repeating unit” is a general term for an atomic group derived from one molecule of a monomer, which is directly formed by polymerizing the monomer, and an atomic group obtained by chemically modifying a part of the atomic group.

In the present specification, (meth)acryl represents acryl and methacryl.

In the present specification, the term “preparing” is meant to include not only an act of carrying out preparation to synthesize and/or mix specific materials but also an act of obtaining a predetermined substance by purchasing or the like.

In the present specification, the term “room temperature” means 25° C. unless otherwise specified.

In the present specification, in a case where a value which may change depending on a temperature is mentioned, the value is a value at 25° C. unless otherwise specified.

In the present specification, a combination of two or more preferred aspects is a more preferred aspect.

Hereinafter, an example of a form for carrying out the present invention will be described.

The present invention is not limited to the following embodiments and can be implemented in variously modified forms within the scope of the gist of the present invention.

### Heat Storage Sheet

A heat storage sheet according to an embodiment of the present invention (hereinafter, also referred to as a “present heat storage sheet”) contains a microcapsule that encompasses a phase change material, a first resin that has a repeating unit derived from an olefin and has a hydrophilic group, and a second resin that is a resin different from the first resin and has a repeating unit derived from an olefin. In addition, a capsule wall of the microcapsule contains at least one resin W selected from the group consisting of polyurethane urea, polyurethane, and polyurea.

The present heat storage sheet exhibits a heat storage function by the transfer and reception of heat of the phase change material encompassed in the microcapsule and absorbs and releases heat in the heat generating element that generates heat.

In particular, due to having excellent followability, the present heat storage sheet is deformed to follow the surface shape of the electronic component, thereby being closely attached to the electronic component without a gap, which makes it possible to sufficiently exhibit the heat absorption function of the heat storage body. In addition, since the present heat storage sheet has excellent heat resistance, deformation hardly occurs even in a high temperature environment, and thus it is possible to suppress a decrease in adhesiveness to a surface of an object.

As described above, the present heat storage sheet can further improve the heat absorption function in a case of being applied to an object such as an electronic component.

The characteristics of the heat storage sheet according to the embodiment of the present invention include that the heat storage sheet includes a combination consisting of a microcapsule having a capsule wall containing a predetermined resin W, a predetermined first resin, and a predetermined second resin.

The detailed mechanism by which the followability and the heat resistance of the heat storage sheet can be improved by selecting a combination of the above-described resins is unknown. However, the inventors of the present invention presume that since the microcapsules are uniformly disposed in the heat storage sheet due to the excellent compatibility between the resin W forming a capsule wall of the microcapsule, the predetermined first resin, and the predetermined second resin, the followability of the heat storage sheet is improved, and the shape and the function of the heat storage sheet are maintained even in a high temperature environment since the first resin and the second resin are excellent in heat resistance.

Hereinafter, each component contained in the present heat storage sheet will be described in detail.

It is noted that in the present specification, the fact that the followability and/or the heat resistance of the object is excellent is also described as “the effect of the present invention is excellent”.

### Microcapsule

The microcapsule has a core part and a capsule wall for encompassing a core material (an encompassed material (also referred to as an encompassed component)) that forms the core part.

The microcapsule encompasses a phase change material as the core material (the encompassed component). Since the phase change material is encompassed in the microcapsule, the phase change material can be stably present in a phase state that depends on the temperature.

### Phase Change Material

The kind of the phase change material is not particularly limited. A material in which the phase changes in response to a temperature change can be used, and it is preferably a material in which a phase change between a solid phase and a liquid phase, accompanied by a state change of melting and solidification in response to a temperature change, is repeated.

The phase change of the phase change material is preferably based on the phase change temperature of the phase change material itself, and in a case of a phase change between a solid phase and a liquid phase, it is preferably based on the melting point.

As the phase change material, for example, any of a material which can store heat which is generated outside the heat storage sheet as sensible heat, a material (hereinafter, also referred to as “latent heat storage material”) which can store heat which is generated outside the heat storage sheet as latent heat, or a material in which a phase change occurs due to a reversible chemical change may be adopted. It is preferable that the phase change material is capable of releasing the stored heat.

Among the above, the phase change material is preferably a latent heat storage material in terms of ease of control of the heat quantity that can be transferred and received and the size of the heat quantity.

The latent heat storage material means a material which stores heat which is generated outside the heat storage sheet, as latent heat. For example, in a case of a phase change between a solid phase and a liquid phase, it refers to a material that can carry out the transfer and reception of heat with the latent heat, by repeating a change between melting and solidification with a melting point determined depending on the material using as a phase change temperature.

In a case of a phase change between a solid phase and a liquid phase, the latent heat storage material can utilize the heat of fusion at the melting point and the heat of solidification at the freezing point, thereby storing heat or dissipating heat in response to the phase change between the solid and the liquid.

The kind of the latent heat storage material is not particularly limited and can be selected from compounds having a melting point and capable of undergoing a phase change.

Examples of the latent heat storage material include ice (water); inorganic salts; aliphatic hydrocarbons such as paraffin (for example, isoparaffin and normal paraffin); fatty acid ester-based compounds such as tri (capryl/capric acid) glyceryl, methyl myristate (melting point: 16° C. to 19° C.), isopropyl myristate (melting point: 167° C.), and dibutyl phthalate (melting point: −35° C.); aromatic hydrocarbons such as an alkyl naphthalene compound such as diisopropyl naphthalene (melting point: 67° C. to 70° C.), a diaryl alkane-based compound such as 1-phenyl-1-xylyl ethane (melting point: less than −50° C.), an alkyl biphenyl-based compound such as 4-isopropyl biphenyl (melting point: 11° C.), a triaryl methane-based compound, an alkylbenzene-based compound, a benzyl naphthalene-based compound, a diaryl alkylene-based compound, and an aryl indane-based compound; natural animal and vegetable oils such as camellia oil, soybean oil, corn oil, cotton seed oil, rape seed oil, olive oil, palm oil, castor oil, and fish oil; mineral oils;diethyl ethers; aliphatic diols; sugars; and sugar alcohols.

The phase change temperature of the phase change material is not particularly limited and may be appropriately selected depending on the kind of the heat generating element that generates heat, the heat generation temperature of the heat generating element, the temperature or holding temperature after cooling, the cooling method.

As the phase change material, it is preferable to select a material having a phase change temperature (preferably a melting point) in a target temperature range (for example, an operation temperature of a heat generating element; hereinafter, also referred to as a “heat control range”).

The phase change temperature (melting point) of the phase change material varies depending on the heat control range, and it may be, for example, 0° C. to 100° C., preferably 10° C. to 100° C., and more preferably 30° C. to 100° C. Among the above, it is still more preferably 50° C. to 95° C., particularly preferably 60° C. to 95° C., and most preferably 65° C. to 95° C. from the viewpoint that the heat storage properties for control of the amount of heat of the heat generating clement or for heat utilization in a high temperature environment are more excellent.

From the viewpoint that the heat storage properties of the heat storage sheet are more excellent, the latent heat storage material is preferably an aliphatic hydrocarbon and more preferably paraffin.

The melting point of the aliphatic hydrocarbon (preferably, paraffin) is not particularly limited, and it is, for example, 0° C. or higher, preferably 10° C. or higher, and more preferably 30° C. or higher, from the viewpoint of various use applications. It is still more preferably 50° C. or higher, particularly preferably 60° C. or higher, and most preferably 65° C. or higher from the viewpoint of application to an object that is used in a high temperature environment, such as an electronic component. The upper limit thereof is not particularly limited; however, it is preferably 100° C. or lower, more preferably 95° C. or lower, and still more preferably 90° C. or lower.

As the aliphatic hydrocarbon, a linear aliphatic hydrocarbon is preferable from the viewpoint that the heat storage properties of the heat storage sheet are more excellent. The number of carbon atoms in the linear aliphatic hydrocarbon is not particularly limited; however, it is preferably 18 or more, more preferably 23 or more, still more preferably 26 or more, and particularly preferably 28 or more. The upper limit thereof is not particularly limited; however, it is preferably 60 or less and more preferably 52 or less.

The content of the linear aliphatic hydrocarbon is preferably 50% to 100% by mass, more preferably 70% to 100% by mass, still more preferably 80% to 100% by mass, and particularly preferably 90% to 100% by mass with respect to the content of the phase change material. In addition, the content of the linear aliphatic hydrocarbon is preferably 80% to 100% by mass, more preferably 90% to 100% by mass, and still more preferably 95% to 100% by mass with respect to the content of the paraffin.

Examples of the linear aliphatic hydrocarbon (linear paraffin) having a melting point of 0° C. or higher include n-tetradecane (C₁₄H₃₀, melting point: 6° C.), n-pentadecane (C₁₅H₃₂, melting point: 10° C.), n-hexadecane (C₁₆H₃₄, melting point: 18° C.), n-heptadecane (C₁₇H₃₆, melting point: 22° C.), n-octadecane (C₁₈H₃₈, melting point: 28° C.), n-nonadecane (C₁₉H₄₀, melting point: 32° C.), n-eicosane (C₂₀H₄₂, melting point: 37° C.), n-henicosane (C₂₁H₄₄, melting point: 40° C.), n-docosane (C₂₂H₄₆, melting point: 44° C.), n-tricosane (C₂₃H₄₈, melting point: 48° C. to 50° C.), n-tetracosane (C₂₄H₅₀, melting point: 52° C.), n-pentacosane (C₂₅H₅₂, melting point: 53° C. to 56° C.), n-hexacosane (C₂₆H₅₄, melting point: 57° C.), n-heptacosane (C₂₇H₅₆, melting point: 60° C.), n-octacosane (C₂₈H₅₈, melting point: 62° C.), n-nonacosane (C₂₉H₆₀, melting point: 63° C. to 66° C.), n-triacontane (C₃₀H₆₂, melting point: 66° C.), hentriacontane (C₃₁H₆₄, melting point: 68° C.), dotriacontane (C₃₂H₆₆, melting point: 69° C.), tritriacontane (C₃₃H₆₈, melting point: 71° C.), n-tetratriacontane (C₃₄H₇₀, melting point: 73° C.), pentatriacontane (C₃₅H₇₂, melting point: 75° C.), n-hexatriacontane (C₃₆H₇₄, melting point: 77° C.), heptatriacontane (C₃₇H₇₆, melting point: 78° C.), and n-octatriacontane (C₃₈H₇₈, melting point: 78° C.).

In a case where paraffin is used as the phase change material, one kind of paraffin may be used alone, or two or more kinds thereof may be mixedly used. In a case where a plurality of kinds of paraffin having melting points different from each other are used, it is possible to expand a temperature range in which the heat storage properties are exhibited.

In a case where a plurality of paraffins are used, the content of the main paraffin is not particularly limited in terms of the temperature range in which the heat storage properties are exhibited and the heat storage amount; however, is preferably 50% to 100% by mass, more preferably 70% to 100% by mass, and still more preferably 90% to 100% by mass with respect to the total mass of the paraffin.

It is noted that the term “main paraffin” refers to the paraffin having the highest content among the plurality of contained paraffins. The content of the main paraffin is preferably 50% by mass or more with respect to the total mass of the paraffin.

The content of the paraffin is not particularly limited; however, it is preferably 80 to 100% by mass, more preferably 90% to 100% by mass, still more preferably 95% to 100% by mass, and particularly preferably 98% to 100% by mass, with respect to the total mass of the phase change material (preferably the latent heat storage material).

The inorganic salt is preferably an inorganic hydrated salt, and examples thereof include a hydrate of a chloride of an alkali metal (for example, sodium chloride dihydrate or the like) a hydrate of an acetate of an alkali metal (for example, sodium acetate water), a hydrate of a sulfate of an alkali metal (for example, a sodium sulfate hydrate), a hydrate of a thiosulfate of an alkali metal (for example, a sodium thiosulfate hydrate), a hydrate of a sulfate of an alkaline earth metal (for example, a calcium sulfate hydrate), and a hydrate of a chloride of an alkaline carth metal (for example, a calcium chloride hydrate).

Examples of the aliphatic diol include 1,6-hexanediol and 1,8-octanediol.

Examples of the sugar and the sugar alcohol include xylitol, erythritol, galactitol, and dihydroxyacetone.

One kind of phase change material may be used alone, or two or more kinds thereof may be mixedly used. In a case of using one kind of phase change material alone, or a plurality kinds thereof having melting points different from each other, it is possible to adjust the temperature range in which the heat storage properties are exhibited and the heat storage amount according to the use application.

Focusing on a phase change material having a melting point at a center temperature at which a heat storage action of a phase change material is desired to be obtained, in a case of mixing a phase change material having melting point smaller or larger than the center temperature, it is possible to expand the temperature range in which the heat storage is possible. As an example, a case where paraffin is used as the phase change material is specifically described as follows; in a case where a paraffin a having a melting point at a center temperature at which a heat storage action of a phase change material is desired to be obtained is used as a center material, and the paraffin a is mixed with another paraffin in which the number of carbon atoms is smaller or larger than that of the paraffin a, a heat storage sheet can be designed to have a wide temperature range (a heat control range).

The content of the phase change material contained in the heat storage sheet is not particularly limited, and it is, for example, 5% by mass or more with respect to the total mass of the heat storage sheet. Among the above, it is preferably 15% by mass or more, more preferably 20% by mass or more, still more preferably 32% by mass or more, and particularly preferably 40% by mass or more with respect to the total mass of the heat storage sheet, from the viewpoint that the heat storage properties are more excellent.

The upper limit thereof is not particularly limited, and it is, for example, 80% by mass or less and preferably 70% by mass or less with respect to the total mass of the heat storage sheet.

The content of the phase change material in the microcapsules is not particularly limited; however, it is preferably 40% by mass or more, more preferably 50% by mass or more, and still more preferably 60% by mass or more with respect to the total mass of the microcapsules, from the viewpoint that the heat storage properties are more excellent.

The upper limit thereof is not particularly limited; however, it is preferably 95% by mass or less, more preferably 85% by mass or less, and still more preferably 70% by mass or less from the viewpoint of the durability and the heat resistance of the microcapsule, in particular, from the viewpoint of further suppressing the bleeding (leakage) of the phase change material in a case where the heat storage sheet is exposed to a high temperature environment.

### Another Core Material

The microcapsule may encompass, as a core material, other components in addition to the above-described phase change material. Examples of other components that can be encompassed in the microcapsule as the core material include additives such as a solvent, an ultraviolet absorbing agent, a light stabilizer, an antioxidant, a wax, an odor suppressant, and a flame retardant.

The content of the phase change material in the core material is not particularly limited. However, it is preferably 80% to 100% by mass and more preferably 90% to 100% by mass with respect to the total mass of the core material from the viewpoint that the heat storage properties of the heat storage sheet are more excellent.

The microcapsule may encompass a solvent as a core material.

In this case, examples of the solvent include the above-described phase change material of which the melting point is outside the temperature range in which the heat storage sheet is used (heat control range; for example, the operating temperature of the heat generating element). That is, the solvent refers to a solvent that does not undergo a phase change in a liquid state in the heat control range, and it is distinguished from a phase change material in which a phase transition occurs in the heat control range and a heat absorption or dissipation reaction occurs.

The content of the solvent in the core material is not particularly limited; however, it is preferably less than 30% by mass, more preferably less than 10% by mass, and still more preferably 1% by mass or less with respect to the total mass of the core material. The lower limit thereof is not particularly limited; however, 0% by mass can be mentioned.

### Capsule Wall (Wall Part)

The microcapsule has a capsule wall encompassing a core material.

The capsule wall of the microcapsule contains at least one resin W selected from the group consisting of polyurethane urea, polyurethane, and polyurea.

It is noted that the polyurethane is a polymer having a plurality of urethane bonds, where it is preferably a reaction product of a polyol and a polyisocyanate.

In addition, the polyurea is a polymer having a plurality of urea bonds, where it is preferably a reaction product of a polyamine and a polyisocyanate.

Further, the polyurethane urea is a polymer having a urethane bond and a urea bond, where it is preferably a reaction product of a polyol, a polyamine, and a polyisocyanate, or a reaction product of a polyol and a polyisocyanate.

It is noted that in a case where a polyol and a polyisocyanate are reacted to obtain polyurethane urea, a part of the polyisocyanate reacts with water to form a polyamine, whereby polyurethane urea is obtained.

The capsule wall of the microcapsule preferably has a urethane bond. The capsule wall having a urethane bond can be obtained by using, for example, the above-described polyurethane urea or polyurethane.

The polyurethane, the polyurea, and the polyurethane urea are preferably formed from a polyisocyanate.

The polyisocyanate is a compound having two or more isocyanate groups, and examples thereof include an aromatic polyisocyanate and an aliphatic polyisocyanate.

Examples of the aromatic polyisocyanate include m-phenylene diisocyanate, p-phenylene diisocyanate, 2,6-tolylene diisocyanate, 2,4-tolylene diisocyanate, naphthalene-1,4-diisocyanate, diphenylmethane-4,4′-diisocyanate, 3,3′-dimethoxy-biphenyldiisocyanate, 3,3′-dimethyldiphenylmethane-4,4′-diisocyanate, xylylene-1,4-diisocyanate, xylylene-1,3-diisocyanate, 4-chloroxylylene-1,3-diisocyanate, 2-methylxylylene-1,3-diisocyanate, 4,4′-diphenylpropane diisocyanate, and 4,4′-diphenylhexafluoropropane diisocyanate.

Examples of the aliphatic polyisocyanate include trimethylene diisocyanate, hexamethylene diisocyanate, propylene-1,2-diisocyanate, butylene-1,2-diisocyanate, cyclohexylene-1,2-diisocyanate, cyclohexylene-1,3-diisocyanate, cyclohexylene-1,4-diisocyanate, dicyclohexylmethane-4,4′-diisocyanate, 1,4-bis(isocyanatemethyl)cyclohexane, 1,3-bis(isocyanatemethyl)cyclohexane, isophorone diisocyanate, lysine diisocyanate, and a hydrogenated xylylene diisocyanate.

It is noted that although the difunctional aromatic polyisocyanate and the aliphatic polyisocyanate have been exemplified in the above description, examples of the polyisocyanate also include a trifunctional or higher functional polyisocyanates (for example, a trifunctional triisocyanate or a tetrafunctional tetraisocyanate).

More specific examples of the polyisocyanate include a biuret form or isocyanurate form which is a trimer of the difunctional polyisocyanate, an adduct (adduct form) of a polyol such as trimethylolpropane and a difunctional polyisocyanate, a formalin condensate of benzene isocyanate, a polyisocyanate having a polymerizable group such as methacryloyloxyethyl isocyanate, and lysine triisocyanate.

The polyisocyanate is described in “Polyurethane Resin Handbook” (edited by Keiji Iwata, published by NIKKAN KOGYO SHIMBUN, LTD., (1987)).

Among them, the polyisocyanate is preferably a trifunctional or higher functional polyisocyanate.

Examples of the trifunctional or higher functional polyisocyanate include a trifunctional or higher functional aromatic polyisocyanate and a trifunctional or higher functional aliphatic polyisocyanate.

Specific examples of the trifunctional or higher functional polyisocyanate include a trimethylolpropane adduct of a polyisocyanate such as 2,6-tolylene diisocyanate, 2,4-tolylene diisocyanate, or hexamethylene diisocyanate (for example, “BURNOCK (registered trademark) D-750” manufactured by DIC Corporation), and a trimer of the above-described difunctional polyisocyanate (a biuret form or isocyanurate form). In addition, examples thereof also include the polyisocyanate described in paragraph [0038] of WO2020/110662A.

In addition, the polyisocyanate is preferably a polymethylene polyphenyl polyisocyanate.

The polymethylene polyphenyl polyisocyanate is preferably a compound represented by Formula (X).

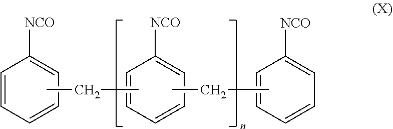

In Formula (X), n represents the number of repeating units. The number of repeating units, n, is, for example, an integer of 1 or more, and it is preferably an integer of 1 to 10 and more preferably an integer of 1 to 5.

Examples of the polyisocyanate including a polymethylene polyphenyl polyisocyanate include Millionate (registered trademark) MR-100, MR-200, and MR-400 (manufactured by Tosoh Corporation); WANNATE (registered trademark) PM-200 and PM-400 (manufactured by Wanhua Chemical Group Co., Ltd.); COSMONATE (registered trademark) M-50, M-100, M-200, and M-300 (manufactured by Mitsui Chemicals, Inc.); and VORANATE (registered trademark) M-595 (manufactured by Dow Chemical Company).

The polyol is a compound having two or more hydroxyl groups, and examples thereof include a low-molecular-weight polyol (for example, an aliphatic polyol or an aromatic polyol), a polyether-based polyol, a polyester-based polyol, a polylactone-based polyol, and a castor oil-based polyol, a polyolefin-based polyol, and a hydroxyl group-containing amine-based compound.

The low-molecular-weight polyol means a polyol having a molecular weight of 500 or less, and examples thereof include difunctional low-molecular-weight polyols such as ethylene glycol, diethylene glycol, or propylene glycol, and trifunctional or higher functional low-molecular-weight polyols such as glycerin, trimethylolpropane, hexanetriol, and pentaerythritol, and sorbitol.

From the viewpoint of improving heat resistance, the polyol is preferably a low-molecular-weight polyol, more preferably a trifunctional or higher functional low-molecular-weight polyol, and still more preferably a trifunctional low-molecular-weight polyol.

Examples of the hydroxyl group-containing amine-based compound include an amino alcohol as an oxyalkylated derivative of an amino compound. Examples of the amino alcohol include N,N,N′,N′-tetrakis[2-hydroxypropyl]ethylenediamine, which is a propylene oxide or ethylene oxide adduct of an amino compound such as ethylenediamine, and N,N,N′,N′-tetrakis[2-hydroxyethyl]ethylenediamine.

The polyamine is a compound having two or more amino groups (a primary amino group and a secondary amino group), and examples thereof include an aliphatic polyvalent amine such as diethylenetriamine, triethylenetetramine, 1,3-propylenediamine, tetraethylenepentamine, or hexamethylenediamine; an epoxy compound adduct of an aliphatic polyvalent amine; an alicyclic polyvalent amine such as piperazine; and a heterocyclic diamine such as 3,9-bis-aminopropyl-2,4,8,10-tetraoxaspiro-(5,5)undecane.

From the viewpoint of improving the heat resistance of the resin, the polyamine is preferably a low-molecular-weight polyamine, more preferably a trifunctional or higher functional low-molecular-weight polyamine, and still more preferably a trifunctional or tetrafunctional low-molecular-weight polyamine.

The low-molecular-weight polyamine means a polyamine having a molecular weight of 500 or less.

Among the above, the resin W contained in the capsule wall preferably has a polymethylene polyphenyl structure from the viewpoint that the bleeding of the phase change material can be further suppressed in a case where the heat storage sheet is exposed to a high temperature environment.

Examples of the polymethylene polyphenyl structure include a structure represented by Formula (Y). The structure represented by Formula (Y) corresponds to a structure included in a resin to be obtained in a case where the compound represented by Formula (X) described above is used as a raw material of the polyisocyanate.

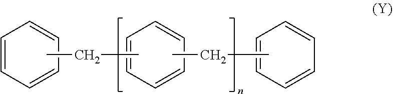

In Formula (Y), n represents the number of repeating units. The number of repeating units, n, is, for example, an integer of 1 or more, and it is preferably an integer of 1 to 10 and more preferably an integer of 1 to 5.

Among the above, the resin W is preferably a resin obtained by reacting an aromatic or alicyclic diisocyanate, a compound having three or more active hydrogen groups in one molecule (hereinafter, also simply referred to as a “polyisocyanate A”), and a polymethylene polyphenyl polyisocyanate (hereinafter, also simply referred to as a “polyisocyanate B”) from the viewpoint that the bleeding of the phase change material can be further suppressed in a case where the heat storage sheet is exposed to a high temperature environment.

The aromatic or aliphatic diisocyanate is preferably an aromatic diisocyanate from the viewpoint of heat resistance. In addition, the compound having three or more active hydrogen groups in one molecule is preferably a polyol and more preferably a low-molecular-weight polyol.

In a case where the polyisocyanate A and the polyisocyanate B are used in combination, the mass ratio of the polyisocyanate A to the polyisocyanate B (the mass of the polyisocyanate A/the mass of the polyisocyanate B) is not particularly limited; however, it is preferably 98/2 to 10/90, more preferably 80/20 to 10/90, and still more preferably 50/50 to 20/80.

The content of the capsule wall in the microcapsule is not particularly limited; however, it is preferably 5% to 60% by mass, more preferably 15% to 60% by mass, and still more preferably 30% to 55% by mass with respect to the total mass of the microcapsules, from the viewpoint that the heat storage properties of the heat storage sheet and the effect of suppressing the bleeding of the phase change material in a case where the heat storage sheet is exposed to a high temperature environment are excellent in a well-balanced manner.

### Physical Properties of Microcapsule

The particle diameter of the microcapsule is not particularly limited; however, it is preferably 1 to 500 μm, more preferably 1 to 200 μm, still more preferably 1 to 100 μm, and particularly preferably 2 to 50 μm in terms of the volume median diameter (Dm) of the microcapsules. In a case where the particle diameter of the microcapsule is small, the appearance of the heat storage sheet is good.

In addition, the average inner diameter of the microcapsules is not particularly limited; however, it is preferably 200 μm or less, more preferably 1 to 100 μm, and still more preferably 2 to 50 μm. The inner diameter of the microcapsule represents the diameter of the core part.

The particle diameter and the inner diameter of the microcapsules can be controlled by changing dispersion conditions in an emulsification step which is described for a manufacturing method for a microcapsule, which will be described later.

The average particle diameter and the average inner diameter of the microcapsules are measured by the following methods.

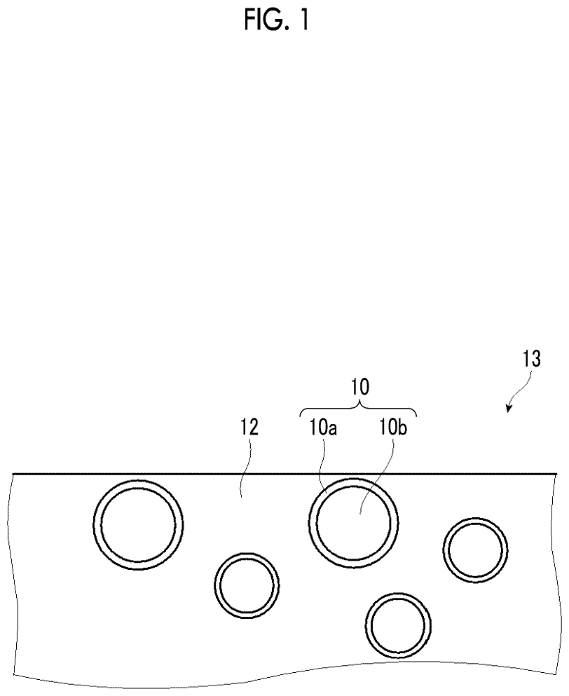

First, a cross section of the heat storage sheet or the resin pellet is prepared, and the cross section thereof is observed at 1,000 times with a scanning electron microscope (SEM). FIG. 1 is a schematic view of a part of an image obtained by observing the cross section of the heat storage sheet with the SEM. In an SEM image of a cross section of a heat storage sheet 13 shown in FIG. 1, an inside (an encompassed substance 10b) of a microcapsule 10, a capsule walls 10a, and an outer region (a resin 12) of the microcapsule are observed in a distinguishable manner. The particle diameters and the inner diameters of at most twenty microcapsules are measured in descending order from the largest microcapsule 10 among the microcapsules 10 present in the observed visual field and arithmetically averaged to determine average values, respectively. It is noted that in a case where the number of the microcapsules 10 present in the visual field is less than 20, the particle diameters and the inner diameters of all the microcapsules are measured and arithmetically averaged to determine average values, respectively. This operation is carried out in five visual fields to determine the average of the average values obtained at each location, and the obtained values are respectively used as the average particle diameter and the average inner diameter of the microcapsules. It is noted that the inner diameter measured as described above is the longest inner diameter in a case where the microcapsule is observed.

The thickness (wall thickness) of the capsule wall of the microcapsule is not particularly limited; however, it is preferably 10.00 μm or less, and it is more preferably 5.00 μm or less and still more preferably 2.00 μm or less from the viewpoint that the heat storage properties of the heat storage sheet are more excellent. On the other hand, since a certain thickness makes it possible to suppress the bleeding of the phase change material in a case where the heat storage sheet is exposed to a high temperature environment and makes it possible to maintain the strength of the capsule wall, the wall thickness is preferably 0.01 μm or more, more preferably 0.10 μm or more, and still more preferably 0.2 μm or more. The wall thickness refers to an average value obtained by measuring individual wall thicknesses (μm) of any twenty microcapsules with a SEM and averaging the obtained measured valucs.

Specifically, a cross section of the heat storage sheet or the resin pellet is prepared, the cross section is observed with a SEM, and twenty microcapsules are selected for the microcapsules having a size of a particle diameter of ±10%, the particle diameter being calculated by the above-described measuring method. The cross sections of the individual selected microcapsules are observed to measure the wall thicknesses, and the arithmetic mean of the measured values of twenty microcapsules is determined to calculate an arithmetic average value, whereby the wall thickness of the microcapsule is determined.

In a case where the particle diameter of the above-described microcapsule is denoted as Dm [unit: μm] and the thickness of the capsule wall of the above-described microcapsule is denoted as δ [unit: μm], the ratio (δ/Dm) of the thickness of the capsule wall of the microcapsule to the particle diameter of the microcapsule is preferably 0.300 or less, more preferably 0.200 or less, and still more preferably 0.100 or less.

The lower limit value of δ/Dm is preferably 0.001 or more, more preferably 0.005 or more, and still more preferably 0.010 or more, from the viewpoint that the hardness of the microcapsule can be maintained.

The glass transition temperature of the capsule wall of the microcapsule is not particularly limited; however, it is preferable that the glass transition temperature thereof is 150° C. or higher, or the capsule wall does not exhibit a glass transition temperature. That is, it is preferable that the glass transition temperature of the material constituting the capsule wall of the microcapsule is 150° C. or higher, or the material constituting the capsule wall of the microcapsule does not exhibit a glass transition temperature.

In a case where the capsule wall of the microcapsule exhibits a glass transition temperature, the glass transition temperature is preferably 160° C. or higher, more preferably 180° C. or higher, and still more preferably 200° C. or higher, from the viewpoint that the heat resistance is more excellent. In a case where the capsule wall of the microcapsule exhibits a glass transition temperature, the upper limit of the glass transition temperature is not particularly limited; however, the glass transition temperature is often equal to or lower than the thermal decomposition temperature of the capsule wall of the microcapsule, and it is generally 250° C. or lower.

Among the above, it is preferable that the capsule wall of the microcapsule does not exhibit a glass transition temperature from the viewpoint that the heat resistance is more excellent.

It is noted that the fact that the capsule wall of the microcapsule does not exhibit a glass transition temperature means that the capsule wall of the microcapsule (the material constituting the capsule wall of the microcapsule) does not exhibit a glass transition temperature in a case of being at a temperature from 25° C. to a temperature (the thermal decomposition temperature −5° C.) obtained by subtracting 5° C. from the thermal decomposition temperature of the capsule wall, which will be described below. That is, it means that the glass transition temperature is not exhibited in a range of “25° C.” to “(thermal decomposition temperature (° C.) −5° C.)”.

A method of adjusting the glass transition temperature of the capsule wall of the microcapsule to be 150° C. or higher or causing the capsule wall not to exhibit a glass transition temperature is not particularly limited, where this adjustment can be carried out by appropriately selecting a raw material used when manufacturing the microcapsule. Examples thereof include a method of constituting the capsule wall with polyurea since polyurea has the property of exhibiting a high glass transition temperature. In addition, examples thereof also include a method of increasing the crosslinking density in a material constituting the capsule wall. Further, examples thereof also include a method of introducing an aromatic ring group (for example, a benzene ring group contained in a polymethylene polyphenylene structure) into a material that constitutes the capsule wall.

Examples of the method of measuring the glass transition temperature of the capsule wall of the microcapsule include the following method.

For example, ethyl acetate is added to the powdery microcapsules before melt kneading, and the resultant mixture is stirred at 25° C. for 24 hours. Then, the obtained solution is filtered, and the obtained residue is subjected to vacuum drying at 60° C. for 48 hours to obtain a microcapsule encompassing nothing inside (hereinafter, also simply referred to as a “measurement material”). That is, a capsule wall material of the microcapsule, which is a measurement target for the glass transition temperature, is obtained.

Next, the thermal decomposition temperature of the obtained measurement material is measured using a thermal gravity-differential thermal analyzer TG-DTA (device name: DTG-60, Shimadzu Corporation). Regarding the thermal decomposition temperature, it is noted that in the thermal gravimetric analysis (TGA) of the atmospheric air atmosphere, a temperature at the time when the mass of the measurement material is reduced by 5% by mass with respect to the mass of the measurement material before heating is defined as the thermal decomposition temperature (° C.) in a case where the temperature of the measurement material has been elevated from room temperature at a constant temperature rising rate (10° C./min).

Next, the glass transition temperature of the measurement material is measured using a differential scanning calorimeter DSC (device name: DSC-60a Plus, Shimadzu Corporation) and using a closed pan, at a temperature rising rate of 5° C./min in a range of 25° C. to (thermal decomposition temperature (° C.) −5° C.). As the glass transition temperature of the capsule wall of the microcapsule, the value at the time of the temperature elevation at the second cycle is used.

The thermal decomposition temperature of the capsule wall of the microcapsule is not particularly limited; however, it is preferably 200° C. or higher, more preferably 220° C. or higher, and still more preferably 230° C. or higher, from the viewpoint that the heat resistance is more excellent.

The thermal decomposition temperature of the capsule wall means a temperature at the time when the mass of the capsule wall is reduced by 5% by mass. The measuring method thereof includes the method using the thermal gravity-differential thermal analyzer TG-DTA (device name: DTG-60, Shimadzu Corporation), which is carried out in measuring the glass transition temperature described above.

The content of the microcapsule in the heat storage sheet is not particularly limited, and it is adjusted such that the content of the phase change material is adjusted to be within the above-described range. More specifically, the content of the microcapsule is preferably 20% to 90% by mass, more preferably 30% to 80% by mass, still more preferably 40% to 75% by mass, and particularly preferably 45% to 70% by mass with respect to the total mass of the heat storage sheet, from the viewpoint that the heat storage properties and the followability of the heat storage sheet are excellent in a well-balanced manner.

In general, it is considered that the heat storage properties are improved by increasing the content of the microcapsule contained in the heat storage sheet, whereas the followability of the heat storage sheet is deteriorated in a case where the content of the microcapsule is excessively increased. As a result, the degree of close attachment to the object may decrease, and thus the improved heat absorption function may not be appropriately exhibited. On the other hand, since the present heat storage sheet has excellent followability, the heat absorption function can be sufficiently exhibited by followability to the applied object even in a case of a heat storage sheet having a higher content of the microcapsule.

### Manufacturing Method for Microcapsule

A manufacturing method for a microcapsule is not particularly limited, and a publicly known method can be employed.

Examples thereof include an interfacial polymerization method including a step (an emulsification step) of dispersing an oil phase containing at least a phase change material and a capsule wall material in a water phase containing at least an emulsifying agent to prepare an emulsified liquid and a step (an encapsulation step) of polymerizing the capsule wall material at the interface between the oil phase and the water phase to form a capsule wall, thereby forming a microcapsule.

The capsule wall material means a material on which a capsule wall can be formed. The capsule wall material contains at least the above-described compound which serves as a raw material of the resin W.

With regard to each step of the interfacial polymerization method, reference can be made to paragraphs [0051] to [0057] of WO2020/110662A, the content of which is incorporated in the present specification by reference.

### First Resin

The present heat storage sheet contains a first resin that has a repeating unit derived from an olefin and has a hydrophilic group.

The olefin is an aliphatic hydrocarbon having at least one ethylenically unsaturated group. The olefin preferably consists of an aliphatic hydrocarbon having at least one ethylenically unsaturated group.

The above-described olefin may be an α-olefin (a linear or branched aliphatic hydrocarbon having one ethylenically unsaturated group at a terminal) or may be a β-olefin or γ-olefin (a linear or branched aliphatic hydrocarbon having one ethylenically unsaturated group at a position other than the terminal), and it is preferably an α-olefin or a β-olefin, and more preferably an α-olefin. The number of carbon atoms in the olefin is, for example, 2 to 10, preferably 2 to 6, and more preferably 2 to 4.

The above-described olefin is preferably ethylene, propylene, i-butene, or n-butene, and more preferably ethylene or propylene.

Examples of the hydrophilic group contained in the first resin include a hydroxy group, an amino group, an alkylamino group, an alkoxy group, an aryloxy group, a cyano group, a nitro group, an acylamino group, an arylamino group, a ureide group, a sulfamoylamino group, an alkylthio group, an arylthio group, an alkoxycarbonamino group, a sulfonamide group, a carbamoyl group, a sulfamoyl group, a sulfonyl group, an alkoxycarbonyl group, a heterocyclic oxy group, an acyloxy group, a carbamoyloxy group, an aryloxycarbonyl group, an aryloxycarbonylamino group, an imide group, a heterocyclic thio group, a phosphoryl group, an acyl group, a carboxy group, a carboxylic acid anhydride group, a sulfo group, and a salt thereof.

Among these, from the viewpoint of the compatibility with the first resin and the viewpoint that the microcapsule is more uniformly disposed, a carboxy group, a carboxylic acid anhydride group, a hydroxy group, an amino group, a phosphoryl group, an alkoxy group, or a sulfonamide group is preferable, a carboxy group, a carboxylic acid anhydride group, a hydroxy group, an amino group, a phosphoryl group, an ethyleneoxy group, or a propyleneoxy group is more preferable, a carboxy group, a carboxylic acid anhydride group, a hydroxy group, or an amino group is still more preferable, and a carboxy group or a carboxylic acid anhydride group is particularly preferable.

It is noted that the carboxylic acid anhydride group means a monovalent substituent obtained by removing any hydrogen atom from a carboxylic acid anhydride such as maleic acid anhydride, itaconic acid anhydride, phthalic acid anhydride, pyromellitic acid anhydride, or trimellitic acid anhydride.

The first resin may have a hydrophilic group in any of the main chain or the side chain; however, it preferably has a hydrophilic group in the side chain.

In addition, the first resin preferably has a main chain consisting of a polyolefin structure.

Among these, the first resin more preferably has an aspect in which at least one of a side chain branched from a main chain consisting of a polyolefin structure or a terminal portion of the main chain has a hydrophilic group, and still more preferably has an aspect in which at least the side chain has a hydrophilic group.

The first resin may be a resin obtained by copolymerization of the above-described olefin and a monomer having a hydrophilic group, or may be a resin obtained by adding a compound having a hydrophilic group to a polymer obtained by polymerization of the above-described olefin.

It is preferable that the first resin has, as a repeating unit derived from an olefin, a repeating unit A represented by Formula (1) (hereinafter, also simply referred to as a “repeating unit A”).

*—{CHR¹¹—CR¹²R¹³}—* (1)

In Formula (1), R¹¹, R¹², and R¹³ each independently represent a hydrogen atom or an alkyl group having 1 to 4 carbon atoms.

* represents a bonding position to an adjacent repeating unit.

R¹¹ and R¹² in Formula (1) are each independently preferably a hydrogen atom or a methyl group and more preferably a hydrogen atom.

R¹³ in Formula (1) is preferably a hydrogen atom, a methyl group, or an ethyl group, and more preferably a hydrogen atom or a methyl group.

The first resin preferably has, in addition to the above-described repeating unit A, at least one selected from the group consisting of a repeating unit B represented by Formula (2-1) (hereinafter, also simply referred to as a “repeating unit B”) and a terminal group represented by Formula (2-2).

*—{CHR²¹—CR²³(LXₙ)}—* (2-1)

*—LXₙ (2-2)

In the formula, R²¹ and R²³ each independently represent a hydrogen atom or an alkyl group having 1 to 4 carbon atoms.

L represents a single bond or an (n+1)-valent linking group.

X represents a carboxy group, a carboxylic acid anhydride group, a hydroxy group, an amino group, a phosphoryl group, an alkoxy group, or a sulfonamide group.

n represents an integer of 1 to 5.

In a case where n is an integer of 2 to 5, a plurality of X's may be the same or different from each other.

* represents a bonding position to an adjacent repeating unit.

R²¹ in Formula (2-1) is preferably a hydrogen atom or a methyl group, and more preferably a hydrogen atom. In addition, it is preferable that R¹¹ and R²¹ are the same.

R²³ in Formula (2-1) is preferably a hydrogen atom, a methyl group, or an ethyl group, and more preferably a hydrogen atom or a methyl group. In addition, it is preferable that R¹³ and R²³ are the same.

The (n+1)-valent linking group represented by L is not particularly limited as long as it is a group that has a valence in accordance with the number of X's. However, examples thereof include an aliphatic hydrocarbon group, a group obtained by substituting at least one methylene group included in an aliphatic hydrocarbon group with a group selected from the group consisting of —O—, —CO—, —NH—, and —NR— (R represents an alkyl group), an aromatic hydrocarbon ring, a heterocyclic ring, and a group obtained by combining these, where an aliphatic hydrocarbon group having 1 to 6 carbon atoms or a group obtained by substituting at least one methylene group included in an aliphatic hydrocarbon group having 2 to 6 carbon atoms with a group selected from the group consisting of —O—, —CO—, and —NH— is preferable, and an aliphatic hydrocarbon group having 1 to 4 carbon atoms is more preferable.

X is preferably a carboxy group, a carboxylic acid anhydride group, a hydroxy group, an amino group, a phosphoryl group, an ethyleneoxy group, or a propyleneoxy group, and more preferably a carboxy group or a carboxylic acid anhydride group.

n is preferably an integer of 1 to 3 and more preferably 1 or 2.

The repeating unit B is preferably a repeating unit different from both the repeating unit derived from acrylic acid and the repeating unit derived from methacrylic acid. In addition, in a case where L represents a single bond, it is preferable that X represents a carboxylic acid anhydride group.

In addition, the term “terminal group” means a group present at a terminal portion of the main chain of the first resin containing the repeating unit A.

Preferred aspects of L, X, and n in Formula (2-2) are the same as those of L, X, and n in Formula (2-1). In a case where the first resin has both the repeating unit B and the terminal group represented by Formula (2-2), L, X, and n in Formula (2-1) and L, X, and n in Formula (2-2) may be the same or different from each other, respectively.

The first resin more preferably has the above-described repeating unit A and the above-described repeating unit B.

It is noted that in the first resin, the bonding modes of the plurality of repeating units are not particularly limited. For example, the plurality of repeating units may be bonded randomly (so-called the random copolymer), may be alternately bonded (so-called the alternating copolymer), or may be bonded in a block shape (so-called the block copolymer).

In addition, it is preferable that the first resin does not substantially contain a halogen atom. Here, the phrase “the first resin does not substantially contain a halogen atom” means that the content of the halogen atom is 1% by mass or less with respect to the total mass of the first resin. The content of the halogen atom in the first resin is more preferably 0.5% by mass or less and still more preferably 0% by mass (equal to or smaller than the detection limit).

The content of the halogen atom contained in the resin such as the first resin or a second resin described later can be measured, for example, by an ion chromatograph method in accordance with IEC 62321-3-2.

From the viewpoint that the compatibility between the capsule and the second resin is more excellent, the acid value of the first resin is preferably 1 to 150 mgKOH/g and more preferably 3 to 120 mgKOH/g.

Here, the acid value is the mass [mg] of potassium hydroxide required for the neutralization of 1 g of a sample, and the unit thereof is described as mgKOH/g in the present specification. The acid value of the first resin can be measured in accordance with the method described in JIS K0070. In addition, in a case where a commercially available product of a resin is used, an acid value described as a catalog value of the commercially available product may be used as the acid value of the resin.

The weight-average molecular weight Mw of the first resin is not particularly limited, and it is, for example, 500 to 100,000 and preferably 1,000 to 80,000.

In the present specification, unless otherwise specified, the weight-average molecular weight Mw is a value obtained by using TSKgel GMHxL, TSKgel G4000HxL, or TSKgel G2000HxL (all of which are manufactured by Tosoh Corporation) as a column, using tetrahydrofuran as an eluent, using a differential refractometer as a detector, using polystyrene as a standard substance, and carrying out conversion using the polystyrene as a standard substance, which has been subjected to measurement with a gel permeation chromatography (GPC) analysis apparatus. In the present specification, unless otherwise specified, the molecular weight of a compound having a molecular weight distribution is a weight-average molecular weight.

The melting point of the first resin is not particularly limited; however, it is preferably 90° C. or higher and more preferably 100° C. or higher from the viewpoint that the heat storage sheet has more excellent heat resistance. The upper limit thereof is not particularly limited; however, it is preferably 300° C. or lower and more preferably 250° C. or lower from the viewpoint that the moldability of the heat storage sheet is more excellent.

Examples of the measuring method for the melting point of a resin or the like include a method using a differential scanning calorimeter (DSC).

One kind of the first resin contained in the heat storage sheet may be used alone, or two or more kinds thereof may be used in combination.

The content of the first resin in the heat storage sheet is not particularly limited; however, it is preferably 1% to 30% by mass, more preferably 3% to 20% by mass, and still more preferably 3% to 15% by mass with respect to the total mass of the heat storage sheet.

### Second Resin

The present heat storage sheet contains a second resin that is a resin different from the first resin and has a repeating unit derived from an olefin.

The olefin in the second resin is the same as the olefin in the first resin, including a preferred aspect thereof.

The second resin is preferably a resin that has a repeating unit derived from an olefin but does not have a hydrophilic group.

It is preferable that the second resin has, as a repeating unit derived from an olefin, a repeating unit C represented by Formula (3) (hereinafter, also simply referred to as a “repeating unit C”).

*—{CH₂—CHR³}—* (3)

In Formula (3), R³ represents a hydrogen atom or an alkyl group having 1 to 4 carbon atoms.

* represents a bonding position to an adjacent repeating unit.

R³ in Formula (3) is preferably a hydrogen atom, a methyl group, or an ethyl group, and more preferably a hydrogen atom or a methyl group.

The second resin may have one kind of the repeating unit C alone or may have two or more kinds thereof.

The second resin may have a repeating unit other than the repeating unit C.

From the viewpoint that the effect of the present invention is more excellent, the first resin and the second resin which are contained in the heat storage sheet preferably have a repeating unit derived from the same olefin.

Among the above, it is more preferable that the repeating unit derived from an olefin, which is contained in the first resin, includes a repeating unit derived from ethylene, and the repeating unit derived from an olefin, which is contained in the second resin, includes a repeating unit derived from ethylene, or the repeating unit derived from an olefin, which is contained in the first resin, includes a repeating unit derived from propylene, and the repeating unit derived from an olefin, which is contained in the second resin, includes a repeating unit derived from propylene, and it is still more preferable that the repeating unit derived from an olefin, which is contained in the first resin, includes a repeating unit derived from propylene, and the repeating unit derived from an olefin, which is contained in the second resin, includes a repeating unit derived from propylene.

It is noted that in the second resin, the bonding modes of the plurality of repeating units are not particularly limited. For example, the plurality of repeating units may be bonded randomly (so-called the random copolymer), may be alternately bonded (so-called the alternating copolymer), or may be bonded in a block shape (so-called the block copolymer).

In addition, it is preferable that the second resin does not substantially contain a halogen atom. Among the above, the content of the halogen atom in the second resin is more preferably 1% by mass or less and still more preferably 0% by mass (equal to or smaller than the detection limit).

The melting point of the second resin is not particularly limited; however, it is preferably 110° C. or higher and more preferably 130° C. or higher from the viewpoint that the heat storage sheet has more excellent heat resistance. The upper limit thereof is not particularly limited; however, it is preferably 300° C. or lower and more preferably 250° C. or lower from the viewpoint that the moldability of the heat storage sheet is more excellent.

The softening point of the second resin is not particularly limited; however, it is preferably 90° C. to 300° C., more preferably 100° C. to 250° C., and still more preferably 110° C. to 200° C., from the viewpoint that the heat resistance and the moldability of the heat storage sheet are more excellent.

A melt flow rate (MFR) of the second resin is preferably 1.0 to 15.0 g/10 min, more preferably 3.0 to 10.0 g/10 min, and still more preferably 3.0 to 8.0 g/10 min. The MFR of the resin can be measured by a method that is in accordance with JIS K 7210.

The density of the second resin is preferably 800 to 1,000 kg/m³ and more preferably 850 to 950 kg/m³. The density of the resin can be measured by a method that is in accordance with JIS K 7112.

The tensile modulus of the second resin is preferably 1 to 3,000 MPa, more preferably 5 to 1,500 MPa, and still more preferably 10 to 1,000 MPa. The tensile modulus of the resin can be measured by a method that is in accordance with ASTM D638.

One kind of the second resin contained in the heat storage sheet may be used alone, or two or more kinds thereof may be used in combination.

The content of the second resin in the heat storage sheet is not particularly limited; however, it is preferably 10% by mass or more, more preferably 15% by mass or more, still more preferably 18% by mass or more, and even still more preferably 20% by mass or more with respect to the total mass of the heat storage sheet. The upper limit thereof is not particularly limited; however, it is preferably 70% by mass or less and more preferably 50% by mass or less from the viewpoint that the heat storage properties of the heat storage sheet are more excellent.

In the heat storage sheet, it is preferable that the content of the second resin is larger than the content of the first resin. That is, the ratio of the content of the first resin to the total content of the first resin and the second resin (content of first resin/total content of first resin and second resin) is preferably less than 50% by mass, and it is more preferably less than 40% by mass and still more preferably 35% by mass or less from the viewpoint that the effect of the present invention is more excellent.

The total content of the first resin and the second resin in the heat storage sheet is not particularly limited, and it is preferable to adjust the content of the phase change material to be set in the above-described range.

From the viewpoint that the effect of the present invention is more excellent and the viewpoint that the heat storage properties of the heat storage sheet are more excellent, the total content of the first resin and the second resin is preferably 10% to 90% by mass, more preferably 15% to 70% by mass, and still more preferably 20% to 65% by mass with respect to the total mass of the heat storage sheet.

### Other Components

The heat storage sheet may include other components of the microcapsule, the first resin, and the second resin.

Examples of other components include a filler, a stabilizer, an oxidizing/reducing agent, a molding aid, a decomposition inhibitor, a lubricant, a mold release agent, a coloring agent such as a pigment, a dispersing agent, and a plasticizer.

The filler is not particularly limited, and examples thereof include an inorganic filler composed of glass, silica, wollastonite, aluminum hydroxide, kaolin, titanium oxide, alumina, mica, talc, carbon, potassium titanate, and the like, and a metal filler composed of copper. The shape of the filler may be a particle shape, a fiber shape, or a whisker shape.

In addition, the heat storage sheet may contain a resin other than the first resin and the second resin.

Examples of another resin include thermoplastic resins such as an acrylonitrile styrene (AS) resin, an acrylonitrile butadiene styrene (ABS) resin, a polyester resin (a polyether ester elastomer or the like), polyvinyl chloride, polyvinylidene chloride, polyamide, an acetal resin, a polycarbonate resin, a polyphenylene sulfide resin, a polyetherimide resin, an aromatic polyether ketone resin, a polysulfone resin, a fluororesin (polyvinylidene fluoride or the like), a polyamidcimide resin, and an acrylic resin.

The content of the other resin is preferably 30% by mass or less and more preferably 15% by mass or less with respect to the total mass of the heat storage sheet. The lower limit thereof is not particularly limited and may be 0% by mass. It is preferable that the heat storage sheet does not contain the other resin described above.

### Physical Properties of Heat Storage Sheet

The thickness of the heat storage sheet is, for example, 100 μm or more. Among the above, it is preferably 200 μm or more, more preferably 300 μm or more, still more preferably 500 μm or more, and particularly preferably 1.0 mm or more, from the viewpoint of further improving the heat storage properties. The upper limit thereof is not particularly limited; however, it is preferably 1 cm or less, more preferably 5 mm or less, and still more preferably 3.5 mm or less, from the viewpoint that the effect of the present invention is more excellent.

The thickness of the heat storage sheet is defined as an arithmetic average value obtained by measuring any five points with a contact-type thickness gauge and determining the arithmetic mean of the measured values.

The latent heat capacity of the heat storage sheet is not particularly limited; however, it is preferably 50 kJ/m² or more, more preferably 100 kJ/m² or more, still more preferably 130 kJ/m² or more, and even still more preferably 200 kJ/m² or more, from the viewpoint that the heat storage composite has high heat storage properties and is suitable for adjusting the temperature of the heat generating element that generates heat. The upper limit thereof is not particularly limited; however, it is 500 kJ/m² or less in many cases.

The latent heat capacity is a heat storage amount (J/g) per unit mass, which is measured by differential scanning calorimetry (DSC), that is, a heat storage amount per area of the heat storage sheet, which is calculated from a density (g/cm³) of a heat storage sheet and a thickness (mm) of the heat storage sheet. The density of the heat storage sheet is measured from the mass and the volume of the sample. The mass of the sample is measured with an electronic balance. In addition, the volume of the sample is determined by measuring the area and the thickness with a caliper, a contact-type thickness measuring instrument, or the like and carrying out a calculation, or it is determined from a volume that has been increased by immersing the sample in a solvent (water, alcohol, or the like) that does not dissolve or swell the sample.

From the viewpoint of improving the followability of the heat storage sheet and further improving the effect of the present invention, it is preferable that the microcapsules are uniformly disposed in the heat storage sheet. The distance between the surfaces of the microcapsules contained in the heat storage sheet is preferably 1 nm or more, more preferably 10 nm or more, still more preferably 50 nm or more, and particularly preferably 100 nm or more. It is meant that the larger the distance between the surfaces is, the more the particles are present in the resin without being aggregated. The upper limit thereof is, for example, 500 μm.

The distance between the surfaces of the microcapsules can be measured by the following method.

The inside of the microcapsules, the capsule walls, and the outer region of the microcapsules are observed in a distinguishable manner with a SEM in the same manner as in the measuring method for the average particle diameter and the average inner diameter of the microcapsules. The outer periphery of the microcapsules present in the observed visual field is traced to measure the average value of the distances between the surfaces of the microcapsules from the traced image, by using an image analysis device. A value calculated by averaging the measured values from a total of 20 points that is obtained from each of the observation images is defined as “the distance between the surfaces” of the microcapsules.

### Manufacturing Method for Heat Storage Sheet

A manufacturing method for the heat storage sheet is not particularly limited, and a publicly known method can be adopted.

Examples of the manufacturing method for the heat storage sheet include a method including a resin pellet manufacturing step of manufacturing resin pellets containing microcapsules, a first resin, and a second resin, and a film forming step of molding the obtained resin pellets into a sheet shape.

### Resin Pellet Manufacturing Step

A method of manufacturing a resin pellet containing the microcapsules, the first resin, and the second resin is not particularly limited, and examples thereof include publicly known methods.

Examples thereof include a method of subjecting a mixture containing the microcapsule, the first resin, and the second resin to melt kneading in an extruder, and then cutting a strand extruded from the extruder to form a pellet.

As an extruder to be used for manufacturing resin pellets, a publicly known device can be used, and examples thereof include a publicly known extrusion molding machine such as a twin-screw extruder.

The microcapsule is preferably handled as a powder. Examples of the method of obtaining the powder of the microcapsule include a method of removing a solvent from the dispersion liquid of the microcapsule obtained according to the above-described interfacial polymerization method to obtain the powder of the microcapsule. Examples of the method of removing a solvent include a method of obtaining a powder of the microcapsule from a dispersion liquid of the microcapsule using a spray dryer.

Among the above, from the viewpoint that the disruption of the microcapsule during melting and kneading can be further suppressed, a method of subjecting the first resin and the second resin to melt kneading in an extruder, adding the microcapsule to a melt of the first resin and the second resin in the extruder, followed by further melt kneading, and cutting a strand extruded from the extruder to manufacture a resin pellet is preferable.

The above-described method can be carried out by using an extruder equipped with a plurality of raw material supply ports. For example, the first resin and the second resin are supplied to an extruder equipped with a plurality of raw material supply ports to be melted and kneaded, the microcapsule is supplied to the extruder from a raw material supply port located downstream of the raw material supply port to which the first resin, and the second resin has been supplied, to be further melted and kneaded, and a strand extruded from the extruder is cut, whereby a resin pellet can be manufactured.

The above method corresponds to a method in which the microcapsule is subjected to side feeding to an extrusion molding machine to be mixed with the first resin and the second resin in a softened state. The side feed is a method in which a feeder that supplies the microcapsule is installed separately from a feeder that supplies the first resin, and the second resin, and the feeder that supplies the microcapsule is charged with respect to the first resin, and the second resin that has been kneaded in advance in the extruder.

### Resin Pellet

The resin pellets manufactured in the above-described resin pellet manufacturing step contain the microcapsules, the first resin, and the second resin, which are described above.

That is, through the above-described resin pellet manufacturing step, it is possible to produce the resin pellet according to the embodiment of the present invention, which contains the microcapsules that encompass a phase change material, the first resin, and the second resin, where the capsule wall of the microcapsules contains the resin W.

The components contained in the resin pellet according to the embodiment of the present invention, including preferred aspects thereof, may be the same as the contents of the respective components contained in the present heat storage sheet, which have already been described.

The resin pellet according to the embodiment of the present invention can be used for manufacturing the present heat storage sheet and can also be used for manufacturing a molded product described later.

The manufacturing method for a resin pellet according to the embodiment of the present invention is not limited to the above-described resin pellet manufacturing step, and a publicly known manufacturing method for a resin pellet can be applied.

The shape of the resin pellet is not particularly limited, and the size thereof is not particularly limited either. The shape of the resin pellet is preferably cylindrical or columnar, and more preferably cylindrical. In a case of a columnar resin pellet, it is preferably a columnar pellet having a height of 0.01 to 100 mm (more preferably 0.05 to 10 mm) and a diameter of 0.01 to 50 mm (more preferably 0.05 to 30 mm).

It is preferable that the heat storage amount of the resin pellet is high. The heat storage amount of the resin pellet is preferably 30 J/g or more, more preferably 50 J/g or more, still more preferably 65 J/g or more, and particularly preferably 80 J/g or more. The upper limit is not particularly limited; however, it is 300 J/g or less in many cases. The heat storage amount can be measured by DSC according to the measuring method for the heat storage amount of the heat storage sheet.

### Film Forming Step

The film forming step is a step of molding the resin pellets manufactured in the above-described step into a sheet shape to manufacture a heat storage sheet containing the microcapsules, the first resin, and the second resin.

A method of molding the resin pellets into a sheet shape in the film forming step is not particularly limited, and examples thereof include publicly known molding methods such as extrusion molding, injection molding, blow molding, compression molding, press molding, and molding with a 3D printer, where extrusion molding is preferable from the viewpoint of excellent productivity.

In the film forming step by extrusion molding, a resin pellet is melted, for example, by using a melt extruder, the molten body is extruded from an extrusion die, and the extruded molten body is subsequently cooled to manufacture a heat storage sheet which is a sheet-shaped extrusion molded product.

Examples of the method of cooling a molten body include a method of cooling a molten body by radiational cooling that occurs between extruding a single film of a molten body through an extrusion die and winding the single film up, and a method of bringing a molten body extruded from an extrusion die into contact with a casting roll and cooling the molten body on the casting roll. In addition, in the cooling of the molten body, it is preferable to further blow air (preferably cold air) to the molten body.

From the viewpoint of excellent productivity, the heat storage sheet is preferably an extrusion molded product manufactured by extrusion molding.

In addition, examples of the manufacturing method for a heat storage sheet, which is different from the method including the resin pellet manufacturing step and the film forming step, include a method including a coating liquid preparation step of mixing the above-described microcapsules, first resin, second resin, and solvent to prepare a coating liquid, a coating step of applying the obtained coating liquid onto a base material to form a coating film, and a drying step of drying the formed coating film.

With regard to the manufacturing method for the heat storage sheet described above, reference can be made to paragraphs [0086] to [0092] of WO2020/110662A, the content of which is incorporated in the present specification by reference.

### Use Application of Heat Storage Sheet

The heat storage sheet can be applied to various applications, and, for example, it can be used to use applications such as electronic devices (for example, a mobile phone (in particular, a smartphone), a mobile information terminal, a personal computer (in particular, a portable personal computer), a game machine, a wireless charger, a camera, a projector, a hard disk, a wearable device (a smart watch, smart glasses, or a headphone), and a remote control); an automobile part (for example, a battery (in particular, a lithium ion battery), a control device such as a power integrated circuit (IC), a car navigation system, a liquid crystal monitor, a light emitting diode (LED) lamp, heat insulation of a canister, and the like); building materials (for example, a floor material, a roof material, and a wall material) suitable for rapid temperature increase during daytime or temperature control during indoor heating or cooling; clothing (for example, underwear, an outer garment, winter clothing, and gloves) suitable for temperature control in response to a change in environmental temperature or a change in body temperature during exercise or at rest; air conditioners; bedding; and waste heat utilization systems that store and use unnecessary waste heat as thermal energy.

Among the above, it is preferable that the heat storage sheet is used for an electronic device (particularly, a portable electronic device). By introducing the heat storage sheet described above into the electronic device, it is possible to suppress the temperature rise of the electronic device while maintaining the airtightness and waterproofness of the electronic device. That is, since the heat storage sheet provides a portion in the electronic device in which heat can be stored for a certain period of time, the surface temperature of the heat generating element in the electronic device can be held in any temperature range.

### Heat Storage Composite

The heat storage sheet to be used for the above-described use applications may have an aspect of a heat storage composite in which the heat storage sheet is combined with a member other than the heat storage sheet. Examples of the member other than the heat storage sheet include an adhesion layer and a protective layer.

The heat storage composite can be applied to the use applications exemplified as the use applications of the heat storage sheet.

For the intended purpose of improving the adhesiveness to an object, the heat storage composite may be a resin sheet with an adhesive layer, which is obtained by providing an adhesive layer on at least one surface of the heat storage sheet.

Examples of the adhesive layer included in the resin sheet with an adhesion layer include a pressure-sensitive adhesive layer and an adhesive layer.

A material of the pressure-sensitive adhesive layer is not particularly limited, and examples thereof include a publicly known pressure sensitive adhesive.

Examples of the pressure sensitive adhesive include an acrylic pressure sensitive adhesive, a rubber-based pressure sensitive adhesive, and a silicone-based pressure sensitive adhesive. In addition, examples of the pressure sensitive adhesive include an acrylic pressure sensitive adhesive, an ultraviolet curing pressure sensitive adhesive, and a silicone pressure sensitive adhesive, which are described in “Characteristic evaluation of peeling paper/peeling film and pressure sensitive adhesive tape and its control technology”, published by Johokiko Co., Ltd., 2004, Chapter 2.

The acrylic pressure sensitive adhesive refers to a pressure sensitive adhesive containing a polymer (a (meth)acrylic polymer) of a (meth)acrylic monomer.

The pressure-sensitive adhesive layer may further contain a pressure-sensitive adhesiveness imparting agent.

A material of the adhesive layer is not particularly limited, and examples thereof include a publicly known adhesive.

Examples of the adhesive include a urethane resin adhesive, a polyester adhesive, an acrylic resin adhesive, an ethylene vinyl acetate resin adhesive, a polyvinyl alcohol adhesive, a polyamide adhesive, and a silicone adhesive.

The thickness of the adhesion layer is not particularly limited; however, it is preferably 0.5 to 100 μm, more preferably 1 to 25 μm, and still more preferably 1 to 15 μm.

Alternatively, a coating amount of the adhesion layer in terms of the pressure sensitive adhesive or the adhesive with respect to the area of the heat storage sheet is preferably 0.1 to 100 g/m², and more preferably 1 to 50 g/m².

The forming method for the adhesion layer is not particularly limited, and examples thereof include a method of applying a pressure sensitive adhesive or a composition containing an adhesive onto a heat storage sheet to form an adhesion layer, and a method of transferring an adhesion layer onto the heat storage sheet.

The protective layer is a layer having a function of protecting a heat storage sheet.

For example, as the protective layer, a layer including a publicly known hard coating agent or a hard coating film, which is disclosed in JP2018-202696A, JP2018-183877A, or JP2018-111793A may be used. From the viewpoint of the heat storage properties, the protective layer including a polymer having heat storage properties, which is described in WO2018/207387A and JP2007-031610A may also be used.

### Molded Product

A molded product according to an embodiment of the present invention (hereinafter, also referred to as a “present molded product”) contains a microcapsule that encompasses a phase change material, a first resin that has a repeating unit derived from an olefin and has a hydrophilic group, and a second resin that is a resin different from the first resin and has a repeating unit derived from an olefin. In addition, a capsule wall of the microcapsule contains at least one resin W selected from the group consisting of polyurethane urea, polyurethane, and polyurea.

Due to having excellent followability, the present molded product sheet is deformed to follow the surface shape of an object, thereby being closely attached to the object without a gap, which makes it possible to sufficiently exhibit the heat absorption function of the heat storage body. In addition, since the present molded product has excellent heat resistance, deformation hardly occurs even in a high temperature environment, and thus it is possible to suppress a decrease in adhesiveness to a surface of an object.

As described above, the present molded product can further improve the heat absorption function in a case of being applied to an object.

The components contained in the present molded product, the physical properties of the present molded product, and the like, including preferred aspects thereof, may be the same as the contents of those in the present heat storage sheet, which have already been described.

The shape of the present molded product is not particularly limited, and it may be, for example, a solid form (three-dimensional shape) such as a sheet shape, a film shape, a plate shape, a cylindrical shape, a spherical shape, a lump shape, a tubular shape, a pipe shape, or a box shape.

The present molded product can be used for various use applications. Examples of the use application of the molded product include, in addition to the same use applications of the heat storage sheet described above, an automobile part, an electronic apparatus part, and a fiber (clothing).

Examples of the automobile part include an engine cover, a battery case, a heat exchanger, an interior part, and an intake system pipe of a vehicle.

Examples of the electronic apparatus part include a housing and a battery case.

The present molded product can be manufactured using, for example, the resin pellets obtained in the above-described resin pellet manufacturing step.

A manufacturing method for the present molded product using the resin pellets is not particularly limited, and a publicly known molding method can be applied. Examples of the molding method include extrusion molding, injection molding, blow molding, compression molding, press molding, and molding with a 3D printer.

A manufacturing method for the present molded product is not limited to the above-described molding method using the resin pellet, and the present molded product may be manufactured by directly molding a mixture containing the microcapsules, the first resin, and the second resin into a desired shape.

The mixture to be used for manufacturing the present molded product, the present heat storage sheet, and the like is not particularly limited as long as it is a mixture containing a combination that consists of microcapsules having a capsule wall containing the predetermined resin W, the predetermined first resin, and the predetermined second resin. The mixture containing the above-described combination may have a shape such as a paste shape, a liquid shape, a powder shape, a clay shape, or a gel shape.

### EXAMPLES

Hereinafter, the characteristics of the present invention will be described more specifically with reference to Examples and Comparative Examples. The material, the using amount, the proportion, the content of treatment, the procedure of treatment, and the like, which are described in the following Examples, can be appropriately modified as long as the gist of the present invention is maintained. Therefore, the scope of the present invention should not be construed to be limited by specific examples described below.

### Production of Microcapsule A

100 parts by mass of paraffin wax (Paraffin Wax-155, manufactured by NIPPON SEIRO Co., Ltd., melting point: 69° C.) as a phase change material was added to 120 parts by mass of ethyl acetate and then heated and dissolved at 75° C. to obtain a solution A. Further, 16 parts by mass of a trimethylolpropane adduct of tolylene diisocyanate (BURNOCK D-750, containing 25% ethyl acetate, manufactured by DIC Corporation), and 40 parts by mass of polymethylene polyphenyl polyisocyanate (Millionate MR-200, manufactured by Tosoh Corporation) were added to the stirred solution A to obtain a solution B. 970 parts by mass of water was added to 170 parts by mass of an aqueous solution of 3% by mass of polyvinyl alcohol (Kuraray Poval 25-88KL, manufactured by Kuraray Co., Ltd.), the obtained mixed liquid was kept at 75° C., and the solution B was added thereto with stirring to carry out emulsification and dispersion. The emulsified liquid after emulsification and dispersion was heated to 85° C. with stirring, and after stirring for 3 hours, the emulsified liquid was cooled. Further, water was added to the obtained solution to adjust the concentration, thereby obtaining a phase change material-encompassing microcapsule liquid having a concentration of solid contents of 15%.

As shown in the following structural formula, BURNOCK D-750 described above corresponds to a trifunctional polyisocyanate which is an adduct form of an aromatic diisocyanate and trimethylolpropane.

Millionate MR-200 described above corresponds to a mixture of diphenylmethane diisocyanate and a polymethylenepolyphenyl polyisocyanate (corresponding to a compound represented by Formula (X)).

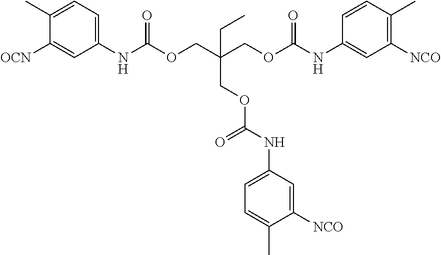

Next, the heat storage material-encompassing microcapsule liquid prepared above was pulverized with a spray dryer (Mini Spray Dryer B-290, manufactured by BUCHI Labortechnik AG) to obtain a powder of a phase change material-encompassing microcapsule A. The particle diameter of the obtained microcapsule A was 15 μm.

### Production of Microcapsules B and C

Microcapsules B and C were produced in the same manner as in the microcapsule A, except that the amount of the phase change material contained in the microcapsules was changed as shown in Table 1.

### Production of Microcapsule D

Microcapsules D were produced in the same manner as in the microcapsule A, except that in the preparation of the phase change material-encompassing microcapsule liquid of Example 1, Millionate MR-200 was not added as a wall material of the microcapsules and the adding amount of BURNOCK D-750 (containing 25% ethyl acetate) was changed to 65.3 parts by mass.

### Production of Microcapsule E

Microcapsules E were produced in the same manner as in the microcapsule A, except that the paraffin wax (Paraffin Wax-155) was changed to paraffin wax (HNP-9, manufactured by NIPPON SEIRO Co., Ltd., melting point: 75° C.) having a melting point of 75° C. as the phase change material.

### Production of Microcapsules F to I

Microcapsules F were produced in the same manner as in the microcapsule A, except that the paraffin wax (Paraffin Wax-155, manufactured by NIPPON SEIRO Co., Ltd.) having a melting point of 69° C. was changed to paraffin wax (Paraffin Wax-145, manufactured by NIPPON SEIRO Co., Ltd.) having a melting point of 63° C. as the phase change material.

Similarly, microcapsules G in which the paraffin wax (Paraffin Wax-155) having a melting point of 69° C. to paraffin wax (Paraffin Wax-140, manufactured by Nippon Seika Co., Ltd.) having a melting point of 61° C., microcapsules H in which the paraffin wax (Paraffin Wax-155) having a melting point of 69° C. was changed to paraffin wax (Paraffin Wax-130, manufactured by Nippon Seika Co., Ltd.) having a melting point of 56° C., and microcapsules I in which the paraffin wax (Paraffin Wax-155) having a melting point of 69° C. was changed to paraffin wax (Paraffin Wax-115, manufactured by Nippon Seika Co., Ltd.) having a melting point of 48° C. were each produced in the same manner as in the microcapsule A.

### Production of Microcapsules J and K

Microcapsules J encompassing 50% by mass of paraffin wax having a melting point of 48° C. as the phase change material and containing a melamine resin as the capsule wall were obtained.

Microcapsules K encompassing 50% by mass of paraffin wax having a melting point of 48° C. as the phase change material and having a polymethyl methacrylate (PMMA) resin as the capsule wall were obtained.

### Example 1

Using a twin-screw extruder (2D25S, manufactured by Toyo Seiki Seisaku-sho, Ltd.) equipped with a first raw material supply port disposed on the upstream side and a second raw material supply port disposed on the downstream side, 10 parts by mass of a resin A described later and 25 parts by mass of PO-A described later were charged into the twin-screw extruder from the first raw material supply port and melted under a condition of a melting temperature of 180° C. In addition, 65 parts by mass of the powder of the phase change material-encompassing microcapsule A was charged into the twin-screw extruder from the second raw material supply port, and a melt of the thermoplastic resin was kneaded with the powder of the phase change material-encompassing microcapsule. The obtained melt in the twin-screw extruder was extruded from a die into a strand, and the strand was cut into a pellet to prepare a cylindrical resin pellet (diameter 3 mm×height 3 mm).

The above-described resin pellets were charged into a melt extrusion molding machine (“GT-20-A”, manufactured by Research Laboratory of Plastics Technology Co., Ltd.) and subjected to melt extrusion molding at an extrusion temperature of 180° C. and a taking-over speed of 1 m/min to produce a heat storage sheet having a thickness of 3 mm.

Further, a pressure sensitive adhesive (“SK-Dyne (registered trademark) 1717DT”, manufactured by Soken Chemical & Engineering Co., Ltd.) was applied to the heat storage sheet at a coating amount of 10 g/m² to produce a heat storage sheet with a pressure sensitive adhesive.

### Examples 2 to 22 and Comparative Example 1

Resin pellets, a heat storage sheet, and a heat storage sheet with a pressure sensitive adhesive were manufactured according to the same procedures as in Example 1, except that at least one selected from the group consisting of the kind of microcapsules to be used, the content of the phase change material in the microcapsules, the kind of the phase change material, the kind of the resin, the amount of each component, and the thickness of the heat storage sheet to be manufactured were changed as shown in Table 1 described later.

The contents of the respective columns shown in Table 1 described later are as follows.

“Urethane A” in the column of “Resin W” of “Microcapsule” means a polyurethane resin A obtained by reacting a trimethylolpropane adduct of tolylene diisocyanate with polymethylene polyphenyl polyisocyanate, and it has a polymethylene polyphenylene structure.

“Urethane B” in the column of “Resin W” of “Microcapsule” means a polyurethane resin B obtained by reacting a trimethylolpropane adduct of tolylene diisocyanate. The polyurethane resin B does not have a polymethylene polyphenylene structure.

The column of “Phase change material/capsule” of “Microcapsule” indicates the content of the phase change material with respect to the total mass of the microcapsules.

In the column of “Phase change material (melting point)” of “Microcapsule”, the melting point (phase transition temperature) (° C.) of the phase change material that is used for manufacturing the microcapsules in each example is shown.

The column of “Amount” of “Microcapsule” indicates the content (unit: % by mass) of the microcapsules with respect to the total mass of the heat storage sheet or the resin pellets.

In the table, the column of “Component 1” indicates the first resin or the reference component.

The column of “Kind” of “Component 1” indicates that the following components are used in each example.
Resin A: “UMEX 5200” manufactured by Sanyo Chemical Industries, Ltd. (maleic acid anhydride-modified polypropylene, melting point: 124° C., acid value: 11 mgKOH/g, Mw: 70,000)
Resin B: “UMEX 1001” manufactured by Sanyo Chemical Industries, Ltd. (maleic acid-modified polypropylene, melting point: 142° C., acid value: 26 mgKOH/g, Mw: 45,000).
Resin C: “Hi-WAX 1105A” manufactured by Mitsui Chemicals, Inc. (maleic acid-modified polyolefin, melting point: 104° C., acid value: 60 mgKOH/g, Mw: 1,500)
Resin D: “ELVALOY AC 3427” (butyl acrylate-based polymer) manufactured by DuPont de Nemours, Inc.

All of the resins A to D correspond to the first resin. The acid values of the resin A and the resin B are values measured by the method described above.

The column of “Amount” of the “Component 1” indicates the content (unit: % by mass) of the component 1 with respect to the total mass of the heat storage sheet or the resin pellets.

The column of “Ratio” of “Component 1” indicates the ratio (unit: % by mass) of the content of the component 1 to the total content of the component 1 and the component 2.

In the table, the column of “Component 2” indicates the second resin or the reference component.

The column of “Kind” of “Component 2” indicates that the following components are used in each example.
PO-A: Polyolefin-modified resin (“TAFMER (registered trademark) PN-2070” manufactured by Mitsui Chemicals, Inc., a thermoplastic resin, melting point: 140° C., softening point: 125° C., density: 867 kg/m³, MFR: 7.0 g/10 min, tensile modulus: 14 MPa)
PO-B: Polyolefin-modified resin (“TAFMER PN-3560” manufactured by Mitsui Chemicals, Inc., a thermoplastic resin, melting point: 160° C., softening point: 135° C., density: 866 kg/m³, MFR: 6.0 g/10 min, tensile modulus: 11 MPa)
PO-C: polyolefin-modified resin (“TAFMER PN-2060” manufactured by Mitsui Chemicals, Inc., a thermoplastic resin, melting point: 160° C., softening point: 120° C., density: 868 kg/m³, MFR: 6.0 g/10 min, tensile modulus: 22 MPa)
PP: Polypropylene resin (“NOVATEC (registered trademark) PP MA-3” manufactured by Japan Polypropylene Corporation, a thermoplastic resin, melting point: 170° C., density: 900 kg/m³, MFR: 11.0 g/10 min, tensile modulus: 1,500 MPa)

All of the above-described resins correspond to the second resin.

The column of “Amount” of “Component 2” indicates the content (unit: % by mass) of the component 2 with respect to the total mass of the heat storage sheet or the resin pellets.

### Comparative Example 2

A heat storage sheet was manufactured with reference to Example 1 of WO2017/221727A. However, the microcapsules K were used as microcapsules contained in the heat storage sheet of Comparative Example 2.

In addition, the heat storage sheet of Comparative Example 2 contains the following components in addition to the microcapsules K.
Polyvinyl chloride (PVC) resin (“ZEST (registered trademark) PQ92” manufactured by SHINDAI-ICHI VINYL CORPORATION, a thermoplastic resin): it is described as “PVC” in the column of “Kind” of “Component 2” in Table 1.
Dispersing agent (manufactured by BYK Additives & Instruments, “Disperplast-1150”, a polar acid ester of long-chain alcohol): it is denoted as “Dispersing agent E” in the column of “Kind” of “Component 1” in Table 1.
Epoxy-based plasticizer (“MONOCIZER W-150” manufactured by DIC Corporation, viscosity: 85 mPa·s, gelation end point temperature: 121° C.)
Heat stabilizer (“GLECK ML-538” manufactured by SHOWA VARNISH CO., LTD.)
Viscosity-reducing agent (manufactured by BYK Additives & Instruments, “VISCO BYK-5125”)

In the table, the column of “Phase change material/heat storage sheet” indicates the content of the phase change material with respect to the total mass of the heat storage sheet.

In the table, the column of “Thickness” indicates the thickness (unit: mm) of each of the heat storage sheets manufactured in Examples and Comparative Examples.

### Evaluation

### Heat Storage Amount

The heat storage amount of each of the heat storage sheets produced in Examples and Comparative Examples was measured by the above-described method using a differential scanning calorimeter (DSC 7020, manufactured by Hitachi High-Tech Science Corporation). The measurement results are shown in Table 1.

### Followability

Each of the heat storage sheets produced in Examples and Comparative Examples was wound around a cylinder having a diameter of 10 cm such that a surface of the heat storage sheet opposite to the surface coated with a pressure sensitive adhesive was in contact with an outer peripheral surface of the cylinder, and then fixing was carried out for 24 hours such that the wound state was maintained. Thereafter, the fixing was released, and the boundary between the cylinder and the heat storage sheet and the appearance of the outer peripheral surface of the heat storage sheet were visually observed to evaluate the followability of the heat storage sheet according to the following standards.
A: The heat storage sheet is wound around the cylinder without a gap, and a change in the surface morphology of the heat storage sheet is confirmed.
B: A gap between the heat storage sheet and the cylinder is confirmed, or cracking is confirmed on the surface of the heat storage sheet.
C: A gap between the heat storage sheet and the cylinder is confirmed, and cracking is confirmed on the surface of the heat storage sheet.

### Heat resistance

Each of the heat storage sheets produced in Examples and Comparative Examples was heated at a temperature of 80° C. for 1 hour. The deformation of the heat storage sheet after heating was visually observed, and the heat resistance of the heat storage sheet was evaluated according to the following standards.
A: Deformation is hardly recognized or not recognized at all.
B: A slight deformation is recognized.
C: A significant modification is recognized.

### Heat Storage Effect

A heat storage sheet with a pressure sensitive adhesive having the same size as a copper plate was bonded to one surface of the copper plate having a size of 10 cm×5 cm×0.5 mm such that the surface coated with a pressure sensitive adhesive faced the copper plate, and a ceramic heater was bonded to the other surface of the copper plate. The copper plate was heated at an output of 6 W by the ceramic heater, and a temperature change of the copper plate was measured with a thermocouple to measure the time taken from the start of the heating to reaching 80° C. It is noted that the temperature of the copper plate before the start of heating was 25° C. From the measured time, the heat storage effect of each heat storage sheet was evaluated according to the following standards.
A: Longer than 300 seconds.
B: Longer than 200 seconds and 300 seconds or shorter.
C: Longer than 100 seconds and 200 seconds or shorter.
D: 100 seconds or less.

### Bleeding

Each of the heat storage sheets produced in Examples and Comparative Examples was subjected to heat treatment at 80° C. for 4 hours. Visual observation was carried out to check whether or not the bleeding (leakage) of the phase change material was observed on the surface of the heat storage sheet which had been subjected to heating treatment, and evaluation was carried out according to the following standards.
A: No bleeding was confirmed.
B: Slight bleeding was confirmed.
C: Bleeding was clearly confirmed.

TABLE 1

| | Microcapsule | | | | | | | | | |
|---|---|---|---|---|---|---|---|---|---|---|
| | | | Phase | Phase | | | | | | |
| | | | change | change | | | | | | |
| | | | materia [symbol] | material | | Component 1 | | | Component 2 | |
| | Kind | Resin W | capsule | ( [symbol] ) | Amount | Kind | Amount | Ratio | Kind | Amount |
| Example 1 | A | Urethane A | 65% | 69° C. | [symbol] | Resin A | 10% | 29% | PO-A | 25% |
| Example 2 | A | Urethane A | 65% | 69° C. | 60% | Resin A | 10% | 25% | PO-A | 30% |
| Example 3 | A | Urethane A | 65% | 69° C. | 70% | Resin A | 11% | 37% | PO-A | 19% |
| Example 4 | B | Urethane A | 75% | 69° C. | 73% | Resin A | 11% | 41% | PO-A | 16% |
| Example 5 | B | Urethane A | 75% | 69° C. | 65% | Resin A | 11% | 31% | PO-A | 24% |
| Example 6 | A | Urethane A | 65% | 69° C. | 73% | Resin A | 11% | 41% | PO-A | 16% |
| Example 7 | D | Urethane B | 65% | 69° C. | 65% | Resin A | 10% | 29% | PO-A | 25% |
| Example 8 | C | Urethane A | 50% | 69° C. | [symbol] | Resin A | 10% | 29% | PO-A | 25% |
| Example 9 | C | Urethane A | 50% | 69° C. | 40% | Resin A | 10% | 17% | PO-A | [symbol] |
| Example 10 | C | Urethane A | 50% | 69° C. | 34% | Resin A | 10% | 15% | PO-A | 56% |
| Example 11 | A | Urethane A | 65% | 69° C. | 65% | Resin A | 10% | 29% | PO-B | 25% |
| Example 12 | A | Urethane A | 65% | 69° C. | 65% | Resin A | 10% | 29% | PO-C | 25% |
| Example 13 | A | Urethane A | 65% | 69° C. | 65% | Resin B | 10% | 29% | PO-A | 25% |
| Example 14 | A | Urethane A | 65% | 69° C. | 65% | Resin C | 10% | 29% | PO-A | 25% |
| Example 15 | E | Urethane A | 65% | 75° C. | 65% | Resin A | 10% | 29% | PO-A | 25% |
| Example 16 | F | Urethane A | 65% | 63° C. | 65% | Resin A | 10% | 29% | PO-A | 25% |
| Example 17 | G | Urethane A | 65% | 61° C. | 65% | Besin A | 10% | 29% | PO-A | 25% |
| Example 18 | H | Urethane A | 65% | 56° C. | 65% | Resin A | 10% | 29% | PO-A | 25% |
| Example 19 | I | Urethane A | 65% | 48° C. | 65% | Resin A | 10% | 29% | PO-A | 25% |
| Example 20 | A | Urethane A | 65% | 69° C. | 65% | Resin A | 10% | 29% | PO-A | 25% |
| Example 21 | A | Urethane A | 65% | 69° C. | 65% | Resin A | 10% | 29% | PO-A | 25% |
| Example 22 | A | Urethane A | 65% | 69° C. | 65% | Resin A | 10% | 29% | PO-A | 25% |
| Comparative | J | — | 50% | 48° C. | [symbol] | Resin D | 20% | 50% | PP | 20% |
| Example 1 | | | | | | | | | | |
| Comparative | K | — | 50% | 48° C. | 26% | Dispersing | 1% | 3% | PVC | 43% |
| Example 2 | | | | | | agent E | | | | |

| | Phase | | | | | | |
|---|---|---|---|---|---|---|---|
| | change | | Evaluation | | | | |
| | materia [symbol] | | Heat | | | | |
| | Heat | | storage | | | Heat | |
| | storage | Thickness | amount | Follow | Heat | storage | |
| | sheet | (nm) | (kJ/m²) | ability | resistance | effect | Bleeding |
| Example 1 | 42% | 3 | 304 | A | A | A | A |
| Example 2 | 39% | 3 | 281 | A | A | A | A |
| Example 3 | 46% | 3 | 328 | A | A | A | A |
| Example 4 | [symbol] | 3 | 394 | B | A | A | B |
| Example 5 | 49% | 3 | 351 | A | A | A | B |
| Example 6 | 47% | 3 | 342 | B | A | A | A |
| Example 7 | 42% | 3 | 304 | A | A | A | C |
| Example 8 | 33% | 3 | 234 | A | A | A | A |
| Example 9 | 20% | 3 | 144 | A | A | A | A |
| Example 10 | 17% | 3 | 122 | A | A | A | A |
| Example 11 | 42% | 3 | 304 | A | A | A | A |
| Example 12 | 42% | 3 | 304 | A | A | A | A |
| Example 13 | 42% | 3 | 304 | A | A | A | A |
| Example 14 | 42% | 3 | 304 | A | A | A | A |
| Example 15 | 42% | 3 | 311 | A | A | A | A |
| Example 16 | 42% | 3 | 298 | A | A | A | A |
| Example 17 | 42% | 3 | 292 | A | A | B | A |
| Example 18 | 42% | 3 | 285 | A | A | C | A |
| Example 19 | 42% | 3 | 279 | A | A | C | A |
| Example 20 | 42% | 4 | 389 | B | A | A | A |
| Example 21 | 42% | 2 | 194 | A | A | B | A |
| Example 22 | 42% | 1 | 97 | A | A | B | A |
| Comparative | 30% | 3 | 198 | C | A | D | A |
| Example 1 | | | | | | | |
| Comparative | 13% | 3 | 85 | A | C | D | A |
| Example 2 | | | | | | | |

[symbol]

indicates data missing or illegible when filed

As shown in Table 1, it has been confirmed that the heat storage sheet and the resin pellet according to the embodiment of the present invention exhibit the desired effect as compared with the heat storage sheets and the resin pellets of Comparative Examples 1 and 2, where the heat storage sheets did not contain a combination of microcapsules, the first resin, and the second resin, and the microcapsules was contained in the capsule wall containing the specific resin W.

From the comparison between Examples 1 to 4 and 6, it has been confirmed that the effect of the present invention is more excellent in a case where the ratio of the content of the first resin to the total content of the first resin and the second resin is less than 40% by mass (reference).

From the comparison between Examples 1 to 5 and 8 to 10, it has been confirmed that the bleeding of the phase change material is further suppressed in a case where the ratio of the content of the phase change material to the total mass of the microcapsules is 70% by mass or less.

From the comparison between Example 7 and Examples other than Example 7, it has been confirmed that the bleeding of the phase change material is further suppressed in a case where the resin W has a polymethylene polyphenylene structure.

From the comparison between Example 10 and Examples other than Example 10, it has been confirmed that the heat storage amount per 1 m² is more excellent in a case where the content of the phase change material is 20% by mass or more with respect to the total mass of the heat storage sheet.

From the comparison between Examples 1 and 15 to 19, it has been confirmed that the heat storage effect is more excellent in a case where the melting point of the phase change material is 50° C. or higher, the heat storage effect is still more excellent in a case where the melting point of the phase change material is 60° C. or higher, and the heat storage effect is particularly excellent in a case where the melting point of the phase change material is 65° C. or higher.

From the comparison between Examples 1 and 20 to 22, it has been confirmed that the effect of the present invention is more excellent in a case where the thickness of the heat storage sheet is 3.5 mm or less.

In addition, from the comparison between Examples 1 and 20 to 22, it has been confirmed that the heat storage effect is more excellent in a case where the thickness of the heat storage sheet is 2.5 mm or more.

### EXPLANATION OF REFERENCES

10: microcapsule
10a: capsule wall
10b: encompassed substance
12: thermoplastic resin
13: heat storage sheet

What is claimed is:

1. A heat storage sheet comprising:
a microcapsule that encompasses a phase change material;
a first resin that has a repeating unit derived from an olefin and has a hydrophilic group; and
a second resin that is a resin different from the first resin and has a repeating unit derived from an olefin,
wherein a capsule wall of the microcapsule contains at least one resin W selected from the group consisting of polyurethane urea, polyurethane, and polyurea.

2. The heat storage sheet according to claim 1,
wherein the repeating unit derived from the olefin, which is contained in the first resin, includes a repeating unit derived from ethylene, and the repeating unit derived from the olefin, which is contained in the second resin, includes a repeating unit derived from ethylene, or
the repeating unit derived from the olefin, which is contained in the first resin, includes a repeating unit derived from propylene, and the repeating unit derived from the olefin, which is contained in the second resin, includes a repeating unit derived from propylene.

3. The heat storage sheet according to claim 1,
wherein the repeating unit derived from the olefin, which is contained in the first resin, includes a repeating unit derived from propylene, and the repeating unit derived from the olefin, which is contained in the second resin, includes a repeating unit derived from propylene.

4. The heat storage sheet according to claim 1,
wherein the hydrophilic group is at least one group selected from the group consisting of a carboxy group, a carboxylic acid anhydride group, a hydroxy group, and an amino group.

5. The heat storage sheet according to claim 1,
wherein a thickness of the heat storage sheet is 200 μm or more.

6. The heat storage sheet according to claim 1,
wherein a melting point of the phase change material is 50° C. to 95° C.

7. The heat storage sheet according to claim 1,
wherein a content of the phase change material is 15% by mass or more with respect to a total mass of the heat storage sheet.

8. The heat storage sheet according to claim 1,
wherein the heat storage sheet is an extrusion molded product.

9. The heat storage sheet according to claim 1,
wherein a content of the second resin is 15% by mass or more with respect to a total mass of the heat storage sheet.

10. The heat storage sheet according to claim 1,
wherein a content of the second resin is larger than a content of the first resin.

11. The heat storage sheet according to claim 1,
wherein the resin W has a polymethylene polyphenylene structure.

12. A resin pellet comprising:
a microcapsule that encompasses a phase change material;
a first resin that has a repeating unit derived from an olefin and has a hydrophilic group; and
a second resin that is a resin different from the first resin and has a repeating unit derived from an olefin,
wherein a capsule wall of the microcapsule contains at least one resin W selected from the group consisting of polyurethane urea, polyurethane, and polyurea.

13. The resin pellet according to claim 12,
wherein the hydrophilic group is at least one group selected from the group consisting of a carboxy group, a carboxylic acid anhydride group, a hydroxy group, and an amino group.

14. The resin pellet according to claim 12,
wherein a melting point of the phase change material is 50° C. to 95° C.

15. The resin pellet according to claim 12,
wherein a content of the phase change material is 15% by mass or more with respect to a total mass of the resin pellet.

16. The resin pellet according to claim 12,
wherein the second resin is a thermoplastic resin, and
a content of the thermoplastic resin is 15% by mass or more with respect to a total mass of the resin pellet.

17. The resin pellet according to claim 12,
wherein a content of the second resin is larger than a content of the first resin.

18. A molded product comprising:
a microcapsule that encompasses a phase change material;
a first resin that has a repeating unit derived from an olefin and has a hydrophilic group; and
a second resin that is a resin different from the first resin and has a repeating unit derived from an olefin,
wherein a capsule wall of the microcapsule contains at least one resin W selected from the group consisting of polyurethane urea, polyurethane, and polyurea.

19. The heat storage sheet according to claim 2,
wherein the hydrophilic group is at least one group selected from the group consisting of a carboxy group, a carboxylic acid anhydride group, a hydroxy group, and an amino group.

20. The heat storage sheet according to claim 2,
wherein a thickness of the heat storage sheet is 200 μm or more.
